(19) United States
(12) Patent Application Publication
(10) Pub. No.: US 2026/0270158 A1
(43) Pub. Date: Sep. 10, 2026

(54) SESSION MANAGEMENT FUNCTION AND USER PLANE FUNCTION INTELLIGENCE AND PROGRAMMABILITY

(71) Applicant: Intel Corporation, Santa Clara, CA (US)

(72) Inventors: Zongrui Ding, Portland, OR (US); Qian Li, Milpitas, CA (US); Alexandre Saso Stojanovski, Paris (FR); Thomas Luetzenkirchen, Taufkirchen (DE); Xiaopeng Tong, Beijing 11 (CN); Dawei Ying, Portland, OR (US); Meghashree Dattatri Kedalagudde, Hillsboro, OR (US); Abhijeet Kolekar, Hillsboro, OR (US)

(21) Appl. No.: 19/165,789

(22) PCT Filed: Apr. 2, 2024
(86) PCT No.: PCT/US2024/022630

§ 371 Date: Sep. 16, 2025

Related U.S. Application Data
(60) Provisional application No. 63/497,155, filed on Apr. 19, 2023.
(60) Provisional application No. 63/499,122, filed on Apr. 28, 2023.
(60) Provisional application No. 63/502,609, filed on May 16, 2023.

(51) Int. Cl. H04L 41/16; G06N 20/00; H04L 41/0803

(52) U.S. Cl. CPC H04L 41/16; G06N 20/00; H04L 41/0803

(57) ABSTRACT

The present disclosure describes session management function (SMF) and user plane function (UPF) interactions, programmability, and intelligence aspects. The SMF may program or deploy a trained machine learning (ML) model to the UPF, and the UPF may operate the trained ML model for performing various UPF-related functions or tasks. The SMF may interact with other network elements, such as a user plane intelligent controller (UP-IC), a real-time intelligent controller (RTIC), and/or a network data analytics function (NWDAF) to train or retrain the ML model based on peformance metrics and/or other triggers, conditions, or criteria. Other embodiments may be described and/or claimed.

### CROSS REFERENCE TO RELATED APPLICATIONS

The present application claims priority to U.S. Provisional App. 63/497,155 filed Apr. 19, 2023 (“′155”), U.S. Provisional App. 63/499,122 filed Apr. 28, 2023 (“′122”), and U.S. Provisional App. 63/502,609 filed May 16, 2023 (“′609”), the contents of each of which are hereby incorporated by reference in their entireties.

### BACKGROUND

In 5G networks, the interactions between the Service Management Function (SMF) and the User Plane Function (UPF) ensure efficient and optimized data delivery. When a user equipment (UE) initiates a session or service request, the SMF communicates with the UPF to establish the data path for the UE's traffic. This involves setting up tunnels and forwarding rules in the UPF. The SMF also configures the UPF with policies based on service requirements and user subscription data, and the UPF enforces the configured policies by applying traffic shaping and forwarding rules.

### BRIEF DESCRIPTION OF THE DRAWINGS

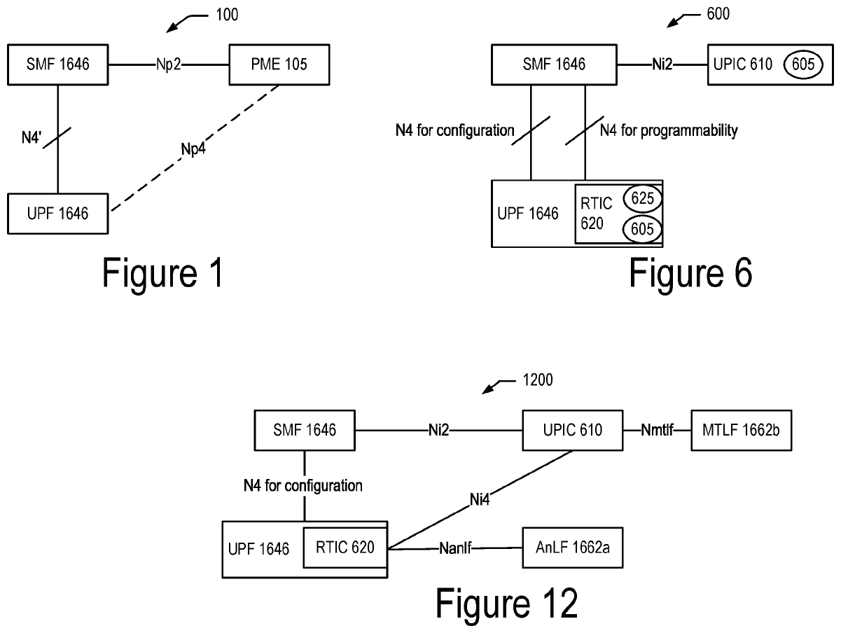

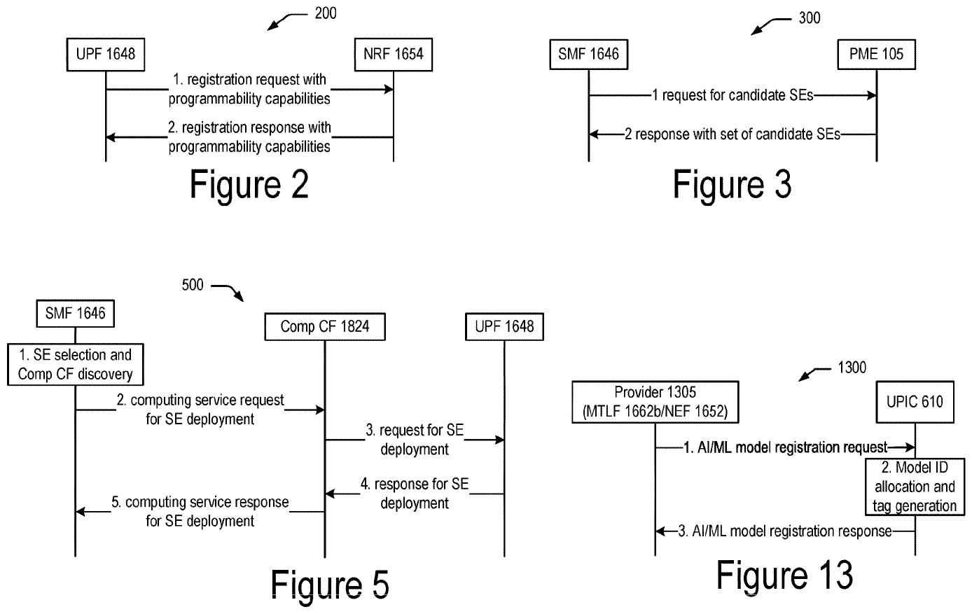

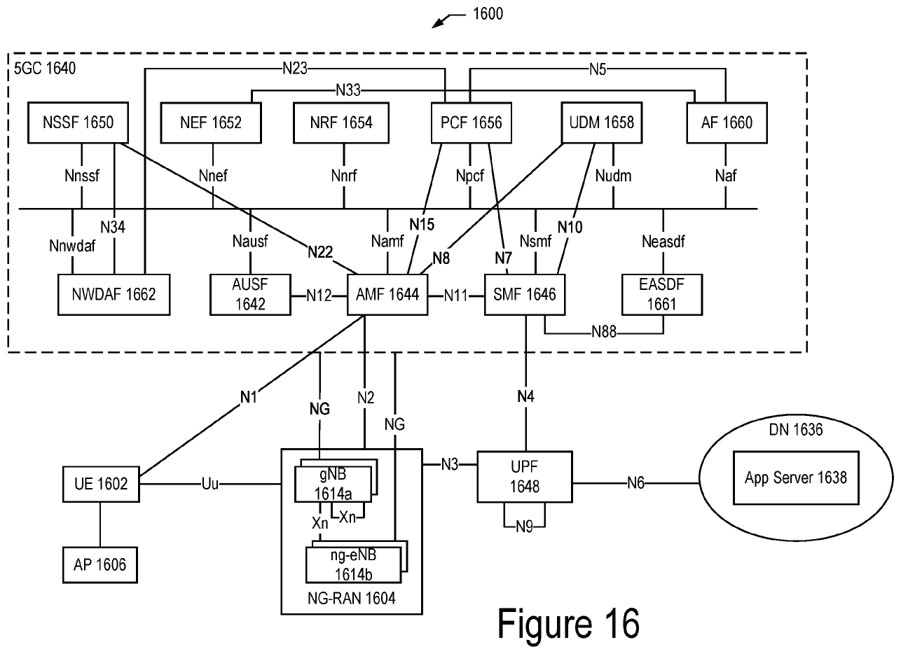

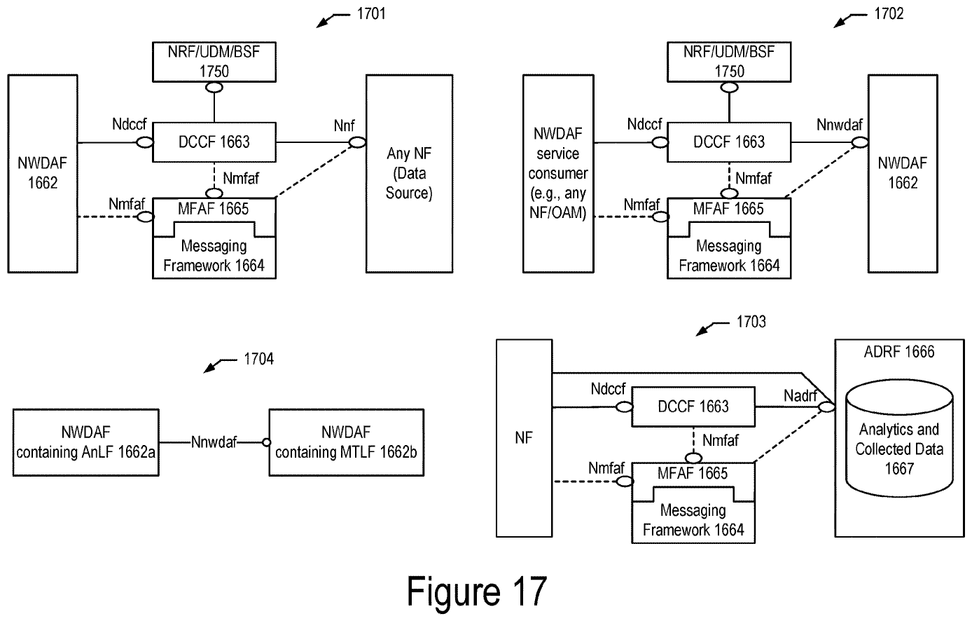

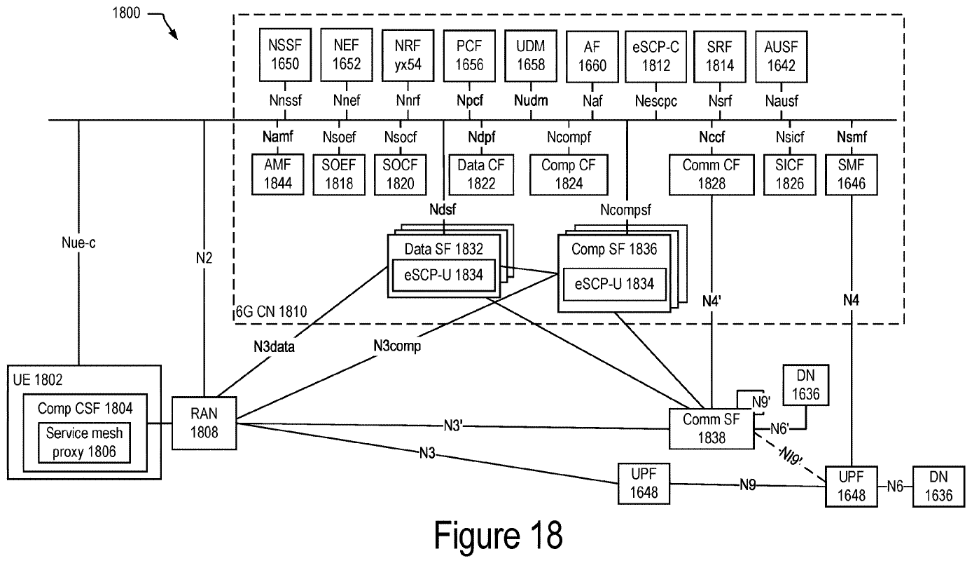

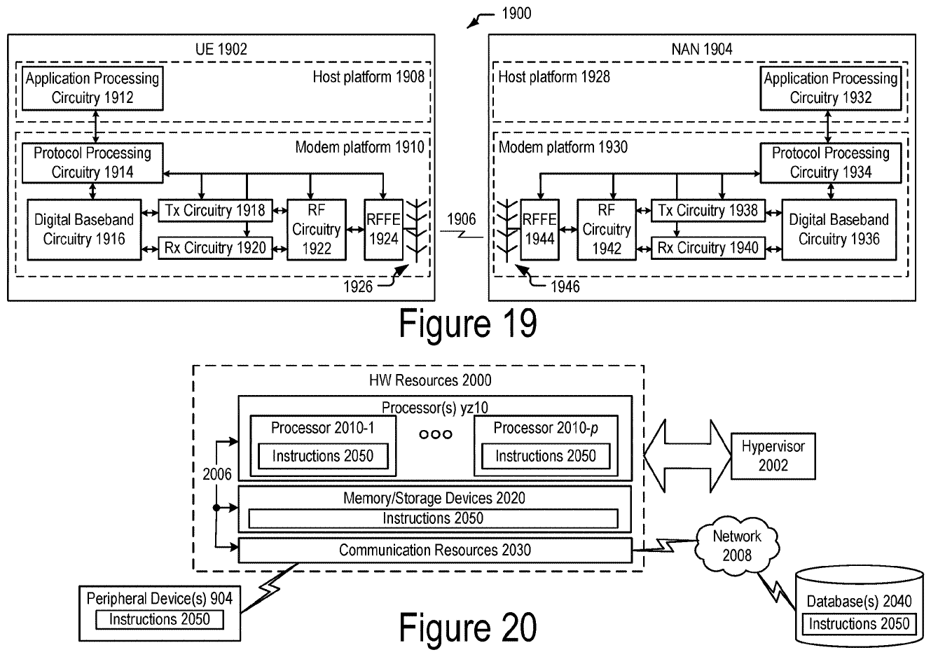

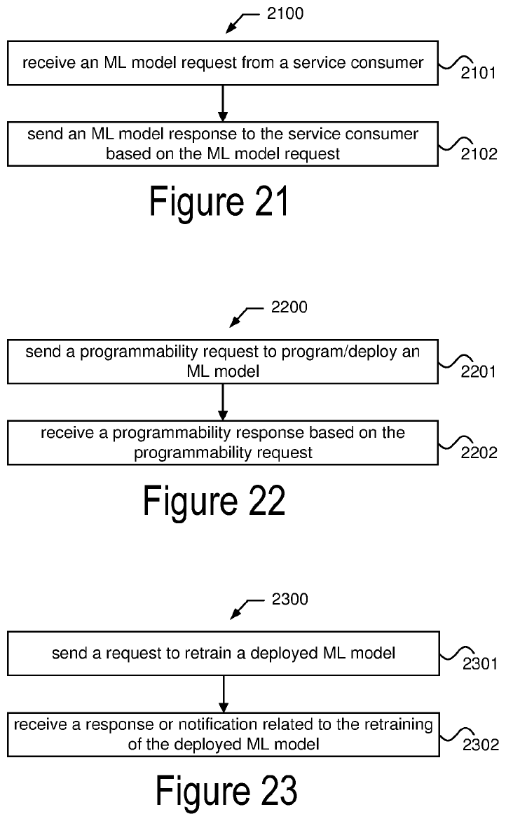

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings in which: FIGS. 1, 6, and 12 illustrate example reference architectures for practicing various aspects of the present disclosure; FIGS. 2, 3, 4, 5, 7, 8, 9, 10, 11, 13, 14, and 15 illustrate example procedures for practicing various aspects of the present disclosure; FIGS. 16 and 18 depict example network architectures; FIG. 17 depicts various example NWDAF frameworks/architectures; FIG. 19 depicts an example wireless network; FIG. 20 depicts example hardware resources; and FIGS. 21, 22, and 23 depict example processes for practicing various aspects discussed herein.

### DETAILED DESCRIPTION

The present disclosure is generally related to wireless communication, cellular networks, cloud computing, edge computing, data centers, network topologies, and communication system implementations, and in particular, to aspects of interactions between a session management function (SMF) and a user plane function (UPF) in 5G networks, including programmability enablement over the N4 interface, SMF and UPF intelligence using AI and ML technologies, and SMF and UPF Intelligence using direct interactions between user plane intelligent controller (UPIC) and/or real-time intelligent controller (RTIC). The various aspects discussed herein allow for the cloudification of wireless/telecommunications networks, which can be implemented using data centers, cloud computing services, edge computing networks, virtualization infrastructure, and/or other hardware (HW) infrastructure. Additionally, the cloudification of wireless/telecommunications networks enables distributed computing of network functions (NFs), provides faster response times, and/or reduces resource consumption and/or overhead.

### 1. Smf and Upf Interaction

3GPP TS 23.502 (“[TS23502]”) and 3GPP TS 29.244 (“[TS29244]”) describe various aspects of the interactions between an SMF (e.g., SMF 1646 in FIG. 16) and a UPF (e.g., UPF 1648 in FIG. 16) via Packet Forwarding Control Protocol (PFCP). There are node level and session level configurations/procedures that can be configured, such as how to classify user plane (UP) packets (e.g., Packet Detection Rule (PDR), Packet Detection Information (PDI), Packet Flow Description (PFD), and/or the like) and how to apply related traffic rules (e.g., Forwarding Action Rules (FAR), QoS Enforcement Rules (QER), Usage Reporting Rules (URR), Buffer Action Rules (BAR), Multi-Access Rules (MAR), and/or the like).

One configuration includes downlink (DL) PDRs for packet classification including both UE-specific aspects and non-UE-specific aspects. For UE-specific rules, a five (5) tuple could be used to detect certain traffic with some heuristic algorithms. In some examples, the five tuple data structure includes a source address (e.g., IP address of a source node), a destination address (e.g., IP address of a destination node), source port number, destination port number, and protocol. These algorithms can be provided by vendors, developers, or operators, and are generally not disclosed to public. For non-UE-specific rules, PFD rules can be provided by an application function (AF) (e.g., AF 1660 in FIG. 16) to specify how to detect traffic for a specific application using a three (3) tuple instead of the 5 tuple together with some additional information such as, for example, one or more URLs in a DNS request.

### 2. Smf and Upf Intelligence Programmability

Due to the undisclosed algorithms for packet classification at the UPF 1648, the N4 interface between the SMF 1646 and the UPF 1648 is not fully open because of the vendor specific information conveyed over that interface. A current 6G trend is to enable end-to-end (e2e) programmability of the cellular network. Therefore, the algorithms (e.g., for packet classification, deep packet inspection, and/or the like) can be dynamically programmed to the UPF 1648 from a vendor via an SMF 1646 of a different vendor. These algorithms can be provided by various vendors, developers, operators, or third parties and not disclosed to other parties/entities. This will provide openness of the N4 interface and interaction between the SMF 1646 and the UPF 1648. For purposes of the present disclosure, the SMF 1646 can discover a UPF 1648 using the NRF (e.g., NRF 1654) and/or using other mechanisms.

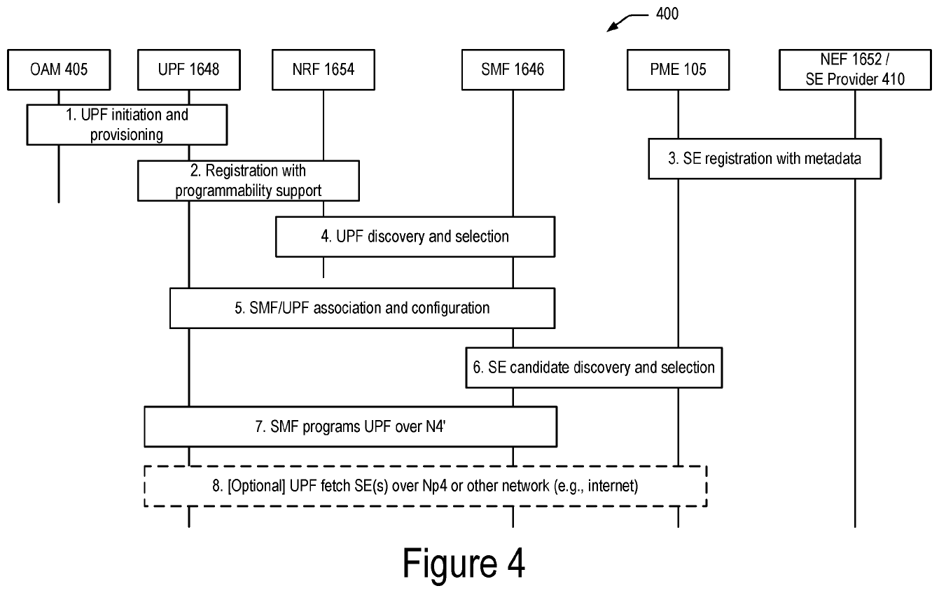

According to various embodiments, to enable the programmability, the SMF 1646 and/or UPF 1648 either directly exchange capabilities related to programmability or exchange capabilities via an NRF 1654. A programmability management entity (PME) is also provided, which allows software element (SE) providers (e.g., SE provider 410 of FIG. 4), which may include developers, vendors, and/or the like, to publish SEs with metadata so that SE consumers (e.g., specific NFs and/or users) can query for available SEs using filters, query parameters, search parameters, constraints, conditions, and/or the like, and deploy/run the SEs.

For purposes of the present disclosure a “software element” or “SE” can refer to one or more applications (apps), AI/ML models (trained or untrained), AI/ML inference engines, AI/ML training functions, application programming interface (API) methods/functions, configurations, datasets, data structures, filters, firmware, functions, middleware, operational parameters, operating systems (OS) or OS images, policies, programs, rulesets, software (SW) agents, SW components, SW engines, SW frameworks, SW images, SW packages, virtualization container or container image, virtual machine (VM) or VM image, and/or any other type of entity, element, and/or collection of executable code that can be deployed/run to accomplish one or more tasks, actions, and/or operations, including any of the elements/entities discussed herein and/or combinations thereof. These SEs can be deployed to any computing node and/or NF, such as any of the NFs discussed herein. In the present disclosure, the UPF 1648 is used as an example NF to which SEs can be programmed or provision to show programmability towards the user plane (UP).

In particular, the present disclosure provides mechanisms for exchanging information along a UPF's 1648 registration to an NRF 1654 about its support for programmability; mechanisms for requesting SEs with a filter to discover desired SEs to consume; and mechanisms for programing UPF aspects (e.g., traffic rules and/or the like) by (or through) the SMF 1646 over an N4 interface. The mechanisms to enable UPF programmability allow the SMF 1646 to configure (or provision) SEs to UPFs 1648 for various purposes, such as traffic rules (e.g., “match” and/or “action”), packet routing and forwarding, packet inspection, lawful interception, traffic usage reporting, QoS handling, traffic verification, packet buffering, packet duplication, traffic steering and splitting (ATSSS), and/or other UPF functionality (e.g., including any mentioned herein) and/or other functions/aspects.

A PME is also introduced to allow SE producers to publish their SEs so that SE consumers can query/search for such SEs (e.g., using search terms, filters, and/or other query parameters) and consume such SEs. In some examples, an “app store” type of interface can be provided that allows consumers to discover relevant SEs published by various producers or developers. Additionally or alternatively, an SMF 1646 can request SE deployment to one or more UFPs 1648 via a Compute Control Function (Comp CF) (e.g., comp CF 1824 of FIG. 18).

### 2.1. Upf Programmability Reference Architecture

FIG. 1 depicts an example reference architecture 100 for enabling UPF programmability. In this example, a programmability management entity (PME) 105 manages the publication, distribution, and consumption of SEs. A SE service provider can publish its SEs to the PME 105 with metadata to describe the SE and/or other aspects. Additionally or alternatively, the UPF 1648 can retrieve a configured/provisioned SE from the PME 105 over an Np4 interface. Additionally or alternatively, the PME 105 can also be the repository of the SEs that can be deployed onto the SE consumers such as the SMF 1646 or UPF 1648. The evolved N4 interface is marked as N4′. A new service N4_ProgrammabilityConfig (request, response) is added to N4′ to enable programmable elements (e.g., traffic rules and/or the like) between SMF 1646 and UPF 1648. In some implementations, the PME 105 is a new NF or implemented as part of an existing NF, such as any of those discussed herein.

Additionally or alternatively, UPF 1648 can provide a new service referred to as a “programmability service” using an SBI that can be accessed by one or more NFs (e.g., SMF 1646, NEF 1652, Comp CF 1824, and/or any other NFs, such as any of those mentioned herein). This SBI enables the NFs to deploy SEs to the UPF 1648 with certain computing related requirements as discussed in sections 2.4 and 2.5 infra.

2.2. Upf Registration with Programmability Capability

A UPF 1648 can register its capability about programmability to an NRF 1654. During registration, the UPF 1648 provides capability information related to its support for programmability in addition to other capability information (e.g., DNN (or LADN DNN), S-NSSAI (or NSSAI), SMF Area Identity, Access Traffic Steering, Switching, Splitting (ATSSS) capabilities, and/or the like) and/or other information for registration purposes.

FIG. 2 shows an example procedure 200 for UPF capability registration to an NRF 1654. Procedure 200 includes the UPF 1648 sending, at operation 1, a registration request with capability information about programmability (e.g., indicating whether the UPF 1648 supports prgrammability and/or other information, including any data/information discussed herein) to the NRF 1654; and the UPF 1648 receiving, at operation 2, a registration response with capability information about programmability (e.g., indicating whether the NRF 1654 supports particular prgrammability services/capabilities and/or other suitable information, including any data/information discussed herein) from the NRF 1654.

The NRF 1654 supports NF registration about profile information, such as NF services (e.g., Nnrf_NFManagement service, Nnrf_NFDiscovery service, Nnrf_AccessToken (OAuth2 Authorization) service, Nnrf_Bootstrapping service, and/or any other NF services discussed in 3GPP TS 29.510 (“[TS29510]”)). For example, the NRF 1654 can indicate, in the registration response (at operation 2 in FIG. 2), its support for programmability services/capabilities in addition to any of the aforementioned NF services.

The capability information about programmability support can be added to the NF profile (see e.g., ‘155, ‘122, and/or [TS29510] §§ 6.1.6.2.2, 6.1.6.2.3). The NF profile (“NFProfile”) is a data type that contains information of an NF instance registered in (or by) the NRF 1654. The NF profile data structure for a particular NF instance includes information of a given NF service instance (“NFService”). As examples, the NF profile can include any combination of the following information/data: whether direct deployment of traffic rules is supported; the number and/or type if traffic rules that can be programmed/provisioned (e.g., PDR, QER, BAR, MAR, and/or the like); acceleration systems/frameworks that can be provided by the UPF 1648, and including manufacturer or vendor specific features (e.g., data plane development kit (DPDK), dynamic load balancer (DLB), QuickAssist Technology (QAT), in-memory analytics accelerator (IAA), data streaming accelerator (DSA), and/or the like); supported computing resource limitation (e.g., maximum number of xPUs (where “x” represents a letter for a particular type of processor, such as “C”, “G”, and/or the like), memory allocation, maximum allowed traffic rules for programmability, and/or the like); a specific service name to support programmability service; and/or any other suitable parameters, conditions, and/or criteria, such as any of the information included in an NF profile and/or as mentioned herein. The programmability service capabilities/support information can be added to the NFprofile for the registration interaction/procedure with the NRF 1654 and/or can include the same or similar NRF data model discussed in [TS29510]. In various implementations, the registration response includes the NFProfile, which is modified to include the programmability capability indicator/data element. Additionally or alternatively, the registration request can include the same or similar information as the NFProfile data structure, and/or includes other data elements discussed in [TS29510] with programmability capability.

Additionally, during a UPF 1648 discovery and selection process, the SMF 1646 stores the UPF information as well as its capability of programmability support, which can be used to generate the program filter discussed infra in section 2.3.

### 2.3. Se Candidate Request Via Np2

FIG. 3 shows an example procedure 300 for requesting SE candidates from a service consumer (e.g., SMF 1646). Procedure 300 may operate as follows.
1) The SMF 1646 sends a request (e.g., an SE candidate request) to the PME 105 to request one or more SEs to be deployed on a UPF 1648. The request for SEs to deploy can include an information filter (e.g., an “SE filter”) to define various query/search parameters for SE candidates. As examples, the filter information can include any combination of the following: identifiers (IDs) and/or capabilities about the UPF 1648 (e.g., DNN, S-NSSAI, SMF Area Identity, ATSSS steering capabilities, and/or the like); SE categories (e.g., type of SE, AI/ML models, AI/ML applications, and/or the like); an intended time period for the SE to run; (if the SE is UE-specific) additional information about one or more UEs 1602 (e.g., UE type, mobility pattern, subscription data, and/or the like); and/or compute capabilities (e.g., HW configuration, number and/or type of processors, number and/or types of accelerators, features that the UPF 1648 can support, and/or the like); performance and/or accuracy that can be achieved by the SE; if the SE includes or involves traffic rules: the types of traffic rules requested (e.g., PDR, QER, BAR, MAR, and/or the like); whether the traffic rule(s) is/are UE-specific or app-specific, and/or the like; traffic categories to be detected (e.g., video, voice, SMS, and/or the like); any combination of the parameters, conditions, and/or criteria as discussed in [MLAS]; and/or any other desired aspects related to desired SEs. In some examples, the PME 105 implements the same or similar search functionalities as discussed in [MLAS].
2) The PME 105 sends a response (e.g., an “SE candidate response”) to the SMF 1646 to indicate whether there are any available SE candidates that meet the SE filter criteria received in operation 1. Additionally or alternatively, the SE candidate response includes a list (set) of SE candidates when at least one SE candidate is found, and includes an error or failure message (with cause value) when no candidate SEs is/are found. The SE candidate response can include additional information, such as information (metadata) about each candidate SE in the list 20 and/or related IDs of each candidate. For example, the information (metadata) about each candidate SE can include SE requirements (e.g., app requirements, platform requirements, image running requirements, and/or the like), vendor-defined restrictions for running the candidate SE, version history of the candidate SE, and/or other suitable information or metadata. Additionally or alternatively, the IDs of individual candidate SEs can include a reference to a resource for retrieving or otherwise accessing a corresponding SE. These references can include, for example, URLs, URIs, pointers, indexes, handles, keys, IDs, universal resource identifiers (URIs), universal resource locators (URLs), domain names, fully qualified domain names (FQDNs), content-based addresses, semantic IDs, and/or any other references, addresses, or pointers to a location where an SE can be accessed or obtained (e.g., these IDs may be included when the actual images themselves are not sent towards the SMF 1646 directly or otherwise included in the SE candidate response). If no available SEs can be found, the PME 105 indicates a failure and cause (e.g., cause value or cause code) in the SE candidate response.

### 2.4. SMF Request Se Deployment on Upf Over N4’

As shown in FIG. 1, SMF 1646 can request a set of SE candidates over the Np2 interface from the PME 105, and determine and/or select an SE from among the SE candidates to be configured or provisioned into the UPF 1648 via the N4′ interface. Additionally or alternatively, the UPF 1648 can be configured with an ID or other reference pointing to an SE storage location and/or the like, and can fetch or otherwise obtain a corresponding SE in a separate message and/or using a separate retrieval mechanism. This fetch request can be sent to the PME 105 via the Np4 interface and/or to other functions which can be implementation specific. An example of such implementations is shown by FIG. 4.

FIG. 4 shows an example procedure 400 where an SMF 1646 requests SE candidates from the PME 105. Procedure 400 may operate as follows:
1) UPF initiation and provisioning takes place, wherein an Operations, Administration, and Maintenance entity/function (OAM) 405 initiates a UPF instance and performs initial provisioning via a management plane.
2) Registration with programmability support takes place, wherein the UPF 1648 registers with an NRF 1654 with programmability support as described in section 2.2, supra.
3) SE registration with the PME 105 takes place, wherein an SE provider 410 publishes one or more SEs to the PME 105 with metadata and/or descriptions of various aspects of the SEs. In some examples, an AF 1660 publishes SE(s) to the PME 105 via an NEF 1652. Additionally or alternatively, a home SMF (H-SMF) 1646 publishes an SE to be used by a visited SMF (V-SMF) 1646 to deploy desired functionality (e.g., traffic rules and/or the like) in a visited network (e.g., visited PLMN and/or the like).
4) UPF discovery and selection takes place, wherein an SMF 1646 queries an NRF 1654 for UPF discovery and selection criteria, conditions, and/or parameters.
5) SMF/UPF association and configuration takes place, wherein the SMF 1646 and UPF 1648 perform associations over the N4 interface.
6) SE candidate discovery and selection takes place, wherein the SMF 1646 sends an SE request (with SE filter) to the PME 105 to obtain SE candidates with desired functionalities and/or requirements as described in section 2.3, supra.
7) The SMF 1646 programs/provisions the UPF 1648 over the N4′ interface. Here, the SMF 1646 selects one or more SE candidates (e.g., from the list of SE candidates obtained in operation 6), and deploys the selected SE(s) to the UPF 1648 via the N4′ interface. This message (e.g., the message for deploying the selected SE(s)) can include any combination of the following: the selected SE(s) can be sent from the SMF 1646 to the UPF 1648 directly if the selected SE(s) is/are sent from the PME 105 to the SMF 1646 in operation 6; a category and/or class of the selected SE(s) (e.g., PDR, QER, BAR, MAR, and/or the like); metadata about the selected SE(s); metadata/information about how to run/deploy the selected SE(s) (e.g., HW platform/configuration requirements, compute resource requirements, such as processor capabilities, accelerators, memory allocation, and/or the like) which may be similar to a JSON, XML, and/or YAML file, and/or the like; an expected run time for the selected SE(s); whether data needs to be collected for the selected SE(s) such as, for example, performance metrics, resource consumption, xPU occupancies, and/or how often the data should be collected and sent to the SMF 1646 and/or other entities (e.g., NWDAF 1662 and/or other NFs); an applied scope of the selected SE(s) (e.g., IDs for UE, UE group, DNN, application ID, S-NSSAI, SMF Area Identity, and/or the like); restrictions on modification of the selected SE(s) (e.g., whether modification is allowed by the UPF 1648 and/or other NFs); events that the SMF 1646 may (e.g., is allowed or permitted to) subscribe to, such as enable/disable notifications, start/stop/pause notifications, performance metrics notifications, when an SE is not delivering performance as expected notifications; and/or the like.
8) Additionally or alternatively, the UPF 1648 fetches or otherwise obtains the selected SE(s) over the Np4 interface and/or over other network (e.g., internet). Here, an ID or reference of one or more of the selected SE(s) can be sent to the UPF 1648 in operation 7 so that the UPF 1648 can fetch or otherwise obtain or access one or more SE(s) via the Np4 interface in a separate message and/or using a separate/difference mechanism. In some examples, one or more SEs can be obtained directly from the SMF 1646 as in operation 7 and one or more other SEs can be obtained via the Np4 interface or other network in operation 8.

### 2.5. Se Deployment Via Comp Cf

In some implementations, the SMF 1646 can request SE deployment or provisioning via a Comp CF 1824 onto/into the UPF 1648. This indicates that the Comp CF 1824 can consume UPF 1648 programmability service(s) via a suitable interface (e.g., a service based interface (SBI), such as Ncompf and/or the like). An example of such implementations is shown by FIG. 5. FIG. 5 shows an example procedure 500 wherein an SMF 1646 requests SE deployment on a UPF 1648 via Comp CF 1824. Procedure 500 may operate as follows:
1) The SMF 1646 performs SE selection (e.g., from a list of SE candidates as described previously), and determines to deploy the selected SE(s) via a Comp CF 1824. The SMF 1646 can perform Comp CF discovery via an NRF 1654 where the SMF 1646 indicates, to the NRF 1654, relevant IDs and/or references (e.g., UPF ID, DNN, S-NSSAI, SMF Area Identity, and/or the like). The NRF 1654 responds to the SMF 1646 with the available Comp CF 1824 and its ID(s) (e.g., network address (e.g., IP address), port number, and/or the like).
2) SMF 1646 sends a computing service request to the Comp CF 1824 to indicate the deployment intent for the selected SE(s) to the UPF 1648. As examples, the computing service request message can include, for each selected SE, an SE ID and/or reference to the SE; deployment requirements for the SE (e.g., deployment start time, stop time, app requirements, HW/platform requirements, resource usage requirements, and/or the like); an ID of the UPF 1648 (e.g., network address (e.g., IP address), port number, and/or the like); and/or any other information/data, such as any information/data mentioned herein.
3) The Comp CF 1824 sends a request for SE deployment to the UPF 1648. This message may be the same or similar to the message(s) used in operation 7 in procedure 400 of FIG. 4, or may be the same or similar to any other SE deployment request message mentioned herein.
4) The UPF 1648 sends an SE deployment response message with the status of the deployment. For example, the SE deployment response message can include a status indicator of “successful”, “failed” (e.g., with cause value(s)), “error” (e.g., with error code(s)), and/or the like.
5) The Comp CF 1824 sends a computing service response to the SMF 1646 to indicate the status of the SE deployment. This message can include the status indicator provided at operation 4, for example, if the deployment failed, the cause value can be provided to the SMF 1646.

### 3. Smf and Upf Intelligence Using AI/ML Technologies

Artificial Intelligence (AI) and Machine Learning (ML) algorithms and techniques are becoming more sophisticated and capable of solving complicated problems with reduced complexity. Some recent research has focused on using AI/ML models for packet classification at a UPF 1648. The AI/ML models can be trained based on data collected in the network in the pre-production stage. Then, the AI/ML models may be further fine tuned based on different data sets and real-time performance metrics. Additional or alternative aspects of ML model training and deployment are discussed in 3GPP TS 28.104 and 3GPP TS 28.105.

The present disclosure describes various mechanism to dynamically deploy AI/ML models to UPFs 1648, which can be part of SMF/UPF programmability described previously (see e.g., section 2 and ‘155). An AI/ML model exposure entity (e.g., UPIC 610) allows an AI/ML model consumer to find a model with defined filter(s), parameters, and/or other desired aspects. In some examples, a model provider can publish an AI/ML model with metadata. The SMF 1646 can discover and select an AI/ML model (e.g., published/produced by one or more model providers) to be deployed on the UPF 1648 (e.g., for packet classification, deep packet inspection (DPI), and/or the like). The UPF 1648 can also update the model and provide data for the AI/ML model to be fine-tuned (e.g., tuning model parameters and/or hyperparameters) and/or retrained. The model tuning and/or retraining can take place at/in the UPF 1648 and/or at/by a different entity. Although the cloudification of the telco networks may require additional computing infrastructure, such cloudification can also provide reduced resource consumption and improved user experience. The present disclosure provides solutions to the following problems: what are the type(s) of information identified as the AI/ML model metadata and model discovery filter; how to expose AI/ML models from different parties to allow SMF 1646 to discover AI/ML models and select an AI/ML model for deployment in the UPF 1648; and how to instruct the UPF 1648 to collect data for model adjustment if the AI/ML models can be fine tuned and/or (re) trained in/at the UPF 1648.

For purposes of the following discussion, packet classification AI/ML models are used as an example to show how intelligence can be enabled at SMFs 1646 and UPFs 1648. However, any other type of AI/ML models can be trained, deployed, and/or tuned according to the examples discussed herein.

### 3.1. Upf Programmability Reference Architecture

In ‘155, the reference architecture for enabling UPF programmability is depicted where the PME 105 manages the publishment (publication) and consumption of SEs. This allows SE service providers (e.g., SE provider 410) to publish their SEs (with metadata that describes the SE and/or other aspects) to the PME 105. Additionally or alternatively, the UPF 1648 can retrieve a configured/provisioned SE image from the PME 105 over an Np4 interface. Additionally or alternatively, the PME 105 can also be the repository of the SEs that can be deployed to SE consumers such as the SMF 1646 and/or the UPF 1648.

FIG. 6 shows another example reference architecture 600 for enabling SMF/UPF intelligence. This reference architecture includes a new service N4_ProgrammabilityConfig that is added to the N4 interface to enable dynamically provisioning/programming of dynamically programmable traffic rules. The reference architecture 600 includes a UPIC 610, which is a function that performs AI/ML model training and exposure to consumers, and as such, is sometimes referred to as an “AI/ML model training and exposure entity”. In some examples, the UPIC 610 includes a model training function (MTF) 605 for training AI/ML models. In some implementations, the UPIC 610 is part of the PME 105 described previously. In other implementations, the UPIC 610 is a separate and/or standalone function. Additionally or alternatively, the UPIC 610 can implement an ML architecture search (see e.g., those discussed in U.S. application Ser. No. 17/497,736 filed on 8 Oct. 2021, U.S. application Ser. No. 17/505,568 filed on 19 Oct. 2021, U.S. application Ser. No. 17/504,282 filed on 18 Oct. 2021, U.S. application Ser. No. 17/504,996 filed on 19 Oct. 2021, and U.S. application Ser. No. 17/506,161 filed on 20 Oct. 2021 (collectively referred to herein as “[MLAS]”)).

The reference architecture 600 also includes an RTIC 620, which is a function that performs inference/prediction determinations by operating one or more AI/ML models and/or AI/ML applications. In some examples, the RTIC 620 includes a model inference function/engine 625 for generating inferences using trained AI/ML models. Additionally or alternatively, the RTIC 620 can perform AI/ML model training, tuning, and/or testing using, for example, a MTF 605. As an example, the AI/ML model trained, tuned, tested, or otherwise operated by the RTIC 620 is a packet classification model, wherein the training, tuning, and/or testing is based on collected traffic traces and/or measurements/metrics. The AI/ML models can be considered to be a special type of SE exchanged over the N4’ interface using N4_ProgrammabilityConfig services. Examples of AI/ML model types, topologies, and/or configurations, and model parameters and/or hyperparameters are discussed in ‘122, ‘609, and/or [MLAS]. In some implementations, the RTIC 620 is implemented or otherwise deployed in the UPF 1648. In other implementations, the RTIC 620 is a separate function that is co-located with the UPF 1648. In various implementations, the UPIC 610 and/or the RTIC 620 is the same or similar as a non-RT RIC and/or the near-RT RIC in O-RAN systems/frameworks.

3.2. Upf Registration to NRF with AI/ML Capability

The UPF 1648 can register its capabilities about AI/ML model support to an NRF 1654. During registration, the UPF 1648 provides information in addition to its capabilities and/or support of programmability related information as discussed previously w.r.t FIG. 2 and/or as discussed in ‘155.

The information related to the UPF's 1648 capabilities for AI/ML model support can include any combination of the following: support for AI/ML models for specific applications or tasks (e.g., traffic rules, packet classification, and/or the like); support for specific AI/ML model types and/or topologies (e.g., neural networks, reinforcement learning, encoder/decoder networks, support vector machines (SVMs), large language models (LLMs), and/or any other types of AI/ML models, such as any of those discussed herein and/or in [MLAS]); supported tasks, actions, and/or operations (e.g., traffic rule categories, packet classification classes/categories, and/or the like); restrictions on vendors or sources of the AI/ML models; restrictions on AI/ML model size and/or programming languages; requirements on HW/SW dependencies of the AI/ML models such as libraries, runtimes, and accelerators, capability of compilation and related SW versions; support for model training; support for model tuning (e.g., including model parameter and/or hyperparameter tuning); support for inference generation; support for dynamic data collection and real-time (RT) telemetry on performance for the AI/ML models; and/or any other information, such as any data/information discussed herein and/or in [MLAS].

### 3.3. UPIC Services for Model Exposure, Training, and Update

The UPIC 610 can provide AI/ML model exposure and training services with metadata.

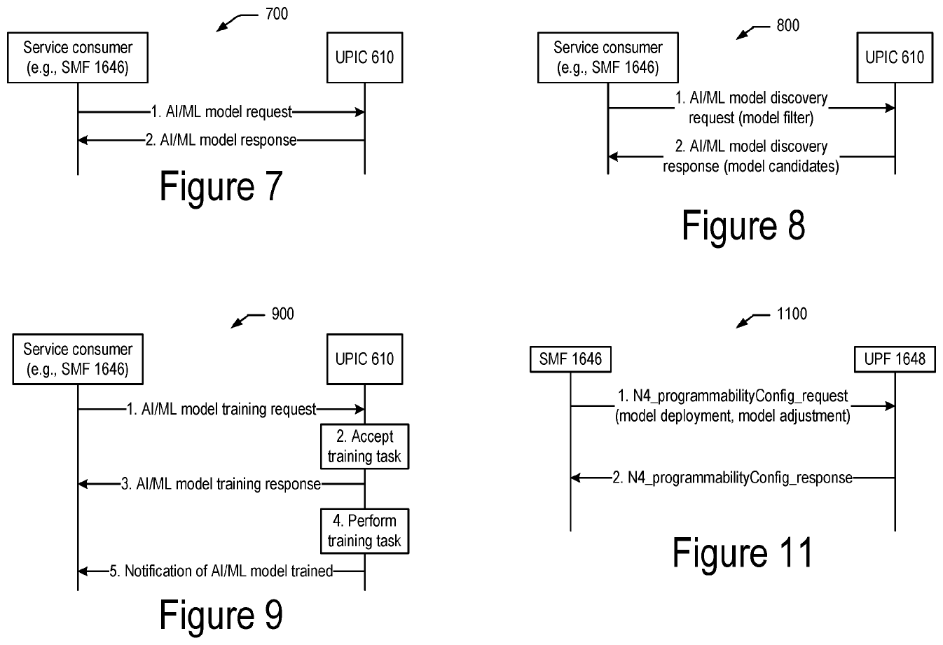

FIG. 7 shows an example procedure 700 for requesting an AI/ML model by a service consumer (e.g., SMF 1646) from the UPIC 610, if the model is stored in/at the UPIC 610. In some implementations, a model repository can be collocated with the UPIC 610 (or is otherwise accessible by the UPIC 610) for storing AI/ML models. Additionally or alternatively, the UPIC 610 may support AI/ML model registration and discovery where the MTF can be supported in a standalone NF, such as an NWDAF-MTLF 1662b (see e.g., FIG. 17 infra and/or [TS29244]) or implemented in or by the UPIC 610 (e.g., MTF 605). Procedure 700 may operate as follows:
1) The service consumer sends an AI/ML model request to the UPIC 610 to request one or more AI/ML models. The model request can include various query/search parameters (or model filter information) describing various aspects of desired AI/ML model(s). As examples, the query/search parameters can include any combination of the following information/parameters: AI/ML model identifier (e.g., a model ID), version number, developer/vendor identity, HW and/or SW platform requirements, model parameters, inference/prediction speed, inference/prediction accuracy, and/or the like. Additionally or alternatively, the AI/ML model request can include various query parameters, such as any of those discussed in [MLAS].
2) The UPIC 610 sends an AI/ML response to the service consumer. As examples, the AI/ML response can include an (updated) AI/ML model, model metadata, and/or the like.

Additionally or alternatively, the AI/ML response can include an ML model ID, address, and/or reference (e.g., URL, FQDN, and/or the like) with the NF ID (e.g., endpoint where the ML model is stored), ML model ID (e.g., applicable to the case where the SMF 1646 provides a traffic rule ID and/or packet classifier ID and not the ID of the specific AI/ML model). Additionally or alternatively, the AI/ML model response can include any of the data/metadata and/or parameters discussed in [MLAS]. If no models match to the query parameters (e.g., model ID, version number, and/or the like), the UPIC 610 can provide suitable error code(s) and/or cause code(s) in the AI/ML model response.

FIG. 8 shows an example procedure 800 for discovering AI/ML model candidates from service consumer (e.g., SMF 1646) to UPIC 610 with a model filter. Procedure 800 may operate as follows:
1) The service consumer (e.g., SMF 1646) sends an AI/ML model discovery request to the UPIC 610 to discover candidate AI/ML models. In this example, the AI/ML model discovery request includes a model filter. As examples, the model filter can include any combination of the following information/parameters:
   (a) IDs and/or other data about the UPF(s) 1648 on which the AI/ML model is to be deployed (e.g., DNN, LADN DNN, NSSAI, S-NSSAI, SMF Area Identity, Access Traffic Steering, Switching, Splitting (ATSSS) capabilities, and/or any other data information and/or any other suitable IDs and/or addresses, such as any of those discussed herein).
   (b) IDs and/or other data about an existing AI/ML model (e.g., model ID, a public model name, any of the information/parameters discussed in section 3.2 and/or in [MLAS])
   (c) The applicability of the AI/ML model such as, for example, whether the AI/ML model is UE-specific, application-specific, node level, and/or session level. If the AI/ML model is UE-specific, additional information about the UE may be provided such as, for example, UE type, mobility pattern, HW and/or SW plaform configuration, UE capabilities, and/or other UE data.
   (d) The input(s) and output(s) of the AI/ML models. For example, a PDR AI/ML model may take a packet header length, PDU size, and/or packet frequency as inputs, and generate an inference about the packet as the output (e.g., classify the packet as being video traffic, voice traffic, XR traffic, a specific type of application traffic, and/or the like).
   (e) Vendor information and/or vendor-related metadata.
   (f) Training data used to train the AI/ML model, metadata about the training data, optimized model parameters, optimized hyperparameters, and/or other metadata and/or historical data about the AI/ML model.
   (g) Performance and/or accuracy that can be achieved by the AI/ML model, intended time for the AI/ML model to run, and/or other performance metrics related to the AI/ML model, such as any of those discussed in [MLAS]. In some examples, the performance and/or accuracy can be expressed as a confidence level and/or using any other means to convey performance/accuracy.
   (h) Whether the AI/ML model is an open source model or proprietary model;
   (i) Whether model tuning is permitted.
   (j) HW/SW computing capabilities such as, for example, accelerators, processor (e.g., xPU) features that the UPF 1648 can support, and/or the like.
   (k) The data set(s) needed to retrain the model or availability of data collection by the UPF 1648 or other entities, such as an NWDAF 1662.
   (l) Any data, parameters, conditions, and/or criteria discussed in [MLAS].

In some implementations, the UPIC 610 performs ML model search operations and/or scaling operations based on the AI/ML model discovery request parameters. The ML model search and/or scaling operations can include any of those discussed in [MLAS].
2) The UPIC 610 sends an AI/ML model discovery response to the SMF 1646 to indicate whether any available candidate AI/ML models that meet the model filter information received in the AI/ML model discovery request have been discovered or found. If at least one match (e.g., at least one candidate AI/ML model) is found, the AI/ML model discovery response includes a list of the candidate AI/ML models. The list of candidate AI/ML models can include a model ID of each candidate AI/ML model in the list and/or can include various metadata about the candidates, such as any of the information mentioned herein. In some implementations, the AI/ML model discovery response includes an SE (e.g., ML model image and/or the like) of one or more of the discovered candidates. Additionally or alternatively, the AI/ML model discovery response includes a reference (e.g., file address/path, storage location, URI, URL, FQDN, and/or the like) of where the service consumer (e.g., SMF 1646) and/or other NF(s) can download or otherwise obtain selected/desired SEs of the candidate AI/ML models. Additional or alternative information, such as SE requirements, vendor restrictions, version history, and/or any other information discussed herein can be sent with the response message. Additionally or alternatively, IDs (e.g., URIs, URLs, FQDNs, UUIDs, and/or the like) towards the model SEs can be included if the actual SEs are not sent towards SMF 1646 directly. If no available models can be found, the UPIC 610 indicates a failure/error and/or cause codes in the response.

In some implementations, the service consumer (e.g., SMF 1646) can forward or otherwise provide the list of candidate AI/ML models to the RTIC 620. Additionally or alternatively, the service consumer (e.g., SMF 1646) can provide the SEs (and/or references to the SEs) to the RTIC 620 for deployment of the selected candidate AI/ML models to the RTIC 620 and/or the UPF 1648. In one example, the SMF 1646 can provide model IDs, references, and/or other information to the RTIC 620 and/or the UPF 1648, and the RTIC 620 and/or the UPF 1648 can download one or more selected ML models using the model IDs, references, and/or other information. In another example, the SMF 1646 can first select an AI/ML model from the list of candidate models, download or otherwise obtain the selected model(s), and then send the obtained model(s) to the RTIC 620 and/or the UPF 1648.

FIG. 9 shows an example procedure 900 for requesting (re-) training of an AI/ML model from a service consumer (e.g., SMF 1646) to the UPIC 610. Procedure 900 may operate as follows:
1) The service consumer sends a subscribes/request to the UPIC 610 to request (re-) training of an AI/ML model. As examples, AI/ML model training request may include any combination of the following information/parameters:
   (a) The AI/ML model ID of the AI/ML model to be (re-) trained. In some implementations, the service consumer can include a version number and/or other metadata/information of the AI/ML model to be (re-) trained.
   (b) Datasets or references to suitable datasets to be used for the AI/ML model (re-) training. These datasets can include, for example, training dataset(s), validation dataset(s), testing dataset(s), emulation dataset(s), and/or the like. In some examples, the service consumer can include new or existing datasets, or dataset IDs in the request.
   (c) Required or desired performance metrics (e.g., accuracy, and/or any of those discussed herein and/or in [MLAS]) and/or thresholds.
   (d) Maximum (re-) training time the service consumer can wait/tolerate.
   (e) A callback URI or other communication mechanism(s) to receive notifications from UPIC 610 when (re-) training is completed.
   (f) NF ID(s) that is/are the data repository where the relevant datasets is/are stored and/or other reference(s) to locations where the relevant datasets is/are stored or can otherwise be obtained. In some examples, a DatasetTag indicating the characteristic of the data (e.g., data collected from a specific UE, or group of UEs, Area of Interest (AoI), and/or the like) can be included in the request.
   (g) Any of the data, parameters, conditions, and/or criteria discussed in [MLAS].
2) The UPIC 610 decides whether to accept or reject the (re-) training request.
3) The UPIC 610 sends a notification/response to the service consumer indicating whether the (re-) training request is accepted or not. Example error/failure causes can include any combination of the following:
   (a) If no available models can be found based on the provided model ID, version number, and/or other metadata, then the UPIC 610 provides suitable error codes in the notification/response.
   (b) If not enough resources are available at the UPIC 610 to handle the (re-) training task(s), then the UPIC 610 provides suitable error codes in the notification/response.
   (c) Target or estimated time period when the (re-) trained AI/ML model using the provided datasets may be completed.
4) The UPIC 610 performs AI/ML model (re-) training tasks/operations.
5) The UPIC 610 sends a notification to the service consumer indicating the (re-) training of the AI/ML model is completed. As examples, the notification may include any combination of the following information/parameters:
   (a) ID(s) of the AI/ML model(s) (e.g., a model ID and/or the like).
   (b) A new version number of the (updated) AI/ML model(s).
   (c) model metadata.
   (d) Any of the data, parameters, conditions, and/or criteria discussed in [MLAS].
   (e) if the updated model is not stored in/by the UPIC 610, reference(s) (e.g., URL to model repository) where the (re-) trained AI/ML model(s) can be obtained/accessed and/or access details/credentials to be used to obtain/access the (re-) trained AI/ML model(s).

### 3.4. AI/ML Model Deployment on Upf Over N4’

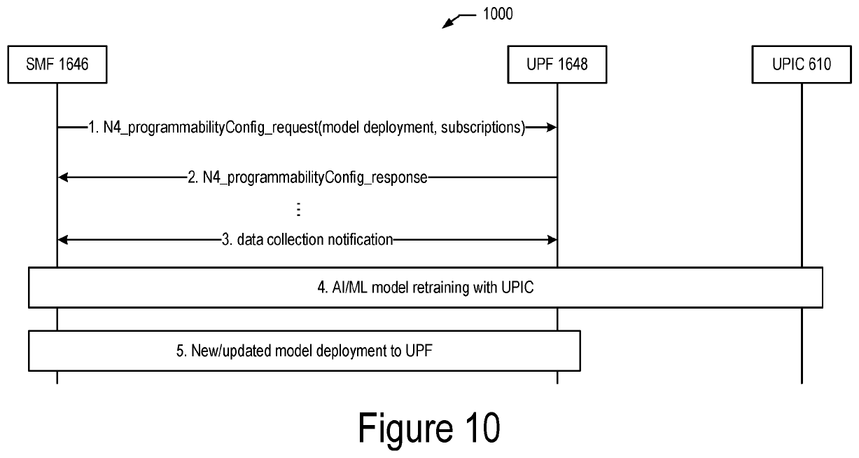

FIG. 10 illustrates an example procedure 1000 for UPIC model (re) training and (re)deployment (e.g., where training takes place in/at the UPIC 610). Here, the SMF 1646 can select an AI/ML model to be deployed on the UPF 1648 over the N4′ interface similar to an SE as described previously and/or in ‘155 § 1.5 (see e.g., FIG. 4, operation 7). In addition, the SMF 1646/UPF 1648 may enable close loop control of different time scales using AI/ML models as shown in FIGS. 8 and 9 (and/or FIGS. 10 and 13). The close loop control in FIG. 8 (or FIG. 10) can work on a larger time scale than that in FIG. 9 (or FIG. 11). Procedure 1000 may operate as follows:
1) The SMF 1646 sends an N4_programmabilityConfig_request to the UPF 1648 for AI/ML model deployment. This operation may be similar to operation 7 in procedure 400 of FIG. 4 (see e.g., section 2.4 supra). The N4_programmabilityConfig_request can also include one or more subscriptions (or subscription requests). Examples of such subscriptions (or subscription requests) include a data collection subscription and an inference notification subscription. The data collection subscription indicates data to be collected to (re-) train the deployed model (e.g., training, testing, validation, and/or emulation datasets) and/or data to be used for inference generation (e.g., inference datasets). The inference notification subscription indicates whether the UPF 1648 can or should send notifications to the SMF 1646 to request the AI/ML model to be (re-) trained based on the inference output observed during deployment (e.g., when in the live network) or just use it for inference. This can differentiate if the AI/ML entity is provided to the UPF 1648 based on PUSH or PULL methods.
2) The UPF 1648 sends an N4_programmabilityConfig_response to confirm the deployment of the AI/ML model, as well as the AI/ML model mode and data subscription. In case of failure, UPF 1648 includes the error codes, cause values, and/or the like.
3) The UPF 1648 notifies the SMF 1646 of data collection for (re-) training. The notification(s) can include relevant information, such as data category, data collection timeframe (and/or timestamps), event(s), and/or the like.
4) AI/ML model retraining takes place with the UPIC 610. Here, the SMF 1646 sends a request to retrain the AI/ML model. This request can include new or existing dataset(s), or can include dataset IDs and/or references (e.g., a URI, URL, FQDN, and/or some other suitable reference, ID, and/or network address, such as any of those discussed herein) to be used to access the dataset(s). In some examples, the dataset(s) can include various combinations of data from different UPFs 1648. For example, the UPIC 610 can provide an updated AI/ML model for the SMF 1646 to deploy in the UPF 1648 with the information identified in section 3.3, FIG. 9 operation 2, and the model (re) training request/response can be similar to those discussed in section 3.3, FIG. 9. The new dataset(s) can be carried with the request in the same request message. Additionally or alternatively, the SMF 1646 can send the training request with a data ID and/or reference pointing to the dataset(s). Here, the UPIC 610 can request or otherwise access the dataset(s) using the dataset ID(s) in a separate message and/or use the reference(s) to access the dataset(s). Additionally or alternatively, the SMF 1646 can include criteria for the dataset(s) to be used by the UPIC 610 to discover and request the dataset(s). The UPIC 610 uses the supplied or obtained dataset(s) to retrain the deployed AI/ML model.
5) An updated (e.g., retrained) AI/ML model can be deployed in/at the UPF 1648 similar to operation 1.

FIG. 11 depicts an example procedure 1100 for SMF/UPF model tuning (e.g., training in/at the RTIC 620 in the UPF 1648). Procedure 1100 may operate as follows:
1) SMF 1646 sends an N4_programmabilityConfig_request for AI/ML model(s) deployment to UPF 1648 similar to operation 7 in procedure 700 of FIG. 7 (see e.g., section 3.3, supra). This request indicates that the model is to be updated based on performance metrics, which can include real-time performance metrics. In some examples, the SMF 1646 indicates to adjust the BUR (or BAR) and/or QER based on telemetry data about the buffer status and QoS for different flows. Additionally or alternatively, the SMF 1646 can also indicate the events that can trigger a model update or a periodic model update. Additionally or alternatively, the SMF 1646 can subscribe to model update events and get notified.
2) The UPF 1648 sends an N4_programmabilityConfig_response to the SMF 1646 to confirm the deployment of the AI/ML model, AI/ML model mode, and/or data subscription. In case of failure or error, the UPF 1648 includes suitable error codes and/or cause values in the N4_programmabilityConfig_response.

### 4. Smf and Upf Intelligence Based on Intelligent Controller Interactions

An NWDAF/DCCF framework to generate data analytics and enable data collection, among other services is described in [TS23288] and infra w.r.t FIG. 17. Programmability aspects of the SMF 1646/UPF 1648 discussed previously (and discussed in ‘155 and ‘122) enable SE(s) to be deployed to a UPF 1648 (e.g., an AI/ML model to perform traffic rules and/or the like). The present disclosure provides additional or alternative architectures to enable interaction between the UPIC 610 and the RTIC 620 to enable SMF 1646/UPF 1648 intelligence, which also leverages the exiting NWDAF aspects discussed herein and/or in [TS23288].

The present disclosure provides additional or alternative architecture(s) to enable a direct interface between the UPIC 610 and the RTIC 620 for AI/ML model (re)deployment and (re) training, which can be based on a “pull” mode or “push” modes. Although the cloudification of the telco networks may require additional computing infrastructure, such cloudification can also provide reduced resource consumption and improved user experience.

### 4.1. Reference Architecture to Interface Between UPIC and RTIC

FIG. 12 depicts an example reference architecture 1200 for enabling SMF and UPF intelligence including interactions between a UPIC 610 and an RTIC 620. As alluded to previously, the UPIC 610 is a function that can perform AI/ML model training and provides exposure services to service consumers. The RTIC 620 is a function that performs inference/prediction determinations by operating one or more AI/ML models and/or AI/ML applications. Additionally or alternatively, the RTIC 620 can perform AI/ML model training, tuning, and/or testing. As an example, the AI/ML model trained, tuned, tested, or otherwise operated by the RTIC 620 is a packet classification model, wherein the training, tuning, and/or testing is based on collected traffic traces and/or measurements/metrics. The AI/ML models can be considered as a (special) SE exchanged over N4’ using the N4_ProgrammabilityConfig services (see e.g., ‘122) Examples of AI/ML model types, topologies, configurations, and/or parameters (e.g., model parameters and/or hyperparameters) are discussed herein and/or in′155, ‘122, and/or ‘609. In some implementations, the RTIC 620 is implemented or otherwise deploy in the UPF 1648. In other implementations, the RTIC 620 is a separate function that is co-located with the UPF 1648. In various implementations, the UPIC 610 and/or the RTIC 620 is the same or similar as the non-RT RIC and/or the near-RT RIC in O-RAN systems.

The UPIC 610 and the RTIC 620 can interact directly with each other via an Ni4 reference point. In some implementations, the UPIC 610 supports only ML model registration and discovery whereas the MTF can be supported in a standalone NF, such as an NWDAF containing MTLF 1662b (“NWDAF-MTLF 1662b” or “MTLF 1662b”). The UPIC 610 can leverage the NWDAF 1662 (e.g., MTLF 1662b) for model (re) training and the RTIC 620 can leverage an NWDAF 1662 (e.g., AnLF 1662a) for analytics using Nmtlf and Nanlf respectively. Additionally or alternatively, the NWDAF-MTLF 1662b can be the role of UPIC 610 and the NWDAF containing AnLF 1662a (“NWDAF-AnLF 1662a”) can be in the role of the RTIC 620. In some implementations, the NWDAF-AnLF 1662a is collocated with the UPF 1648 and can provide analytics specific to, for example, packet classification and/or the like.

### 4.2. AI/ML Model Id and Traffic Rule Tags

In various embodiments, a model (service) consumer (e.g., SMF 1646) can request an AI/ML model from the UPIC 610 using a model ID, which can be discovered/configured via a separate procedure. In some examples, an AF 1660 can provide an AI/ML model to be used as a traffic profile for PFD and configures a model ID to an SMF 1646 as part of a policy and charging control (PCC) rule. Additionally or alternatively, an SMF 1646 in the role of service consumer can provide ML model filter information to the UPIC 610 to discover all available AI/ML models identified as a list of model IDs. Then, the SMF 1646 selects an AI/ML model from the list, and requests the AI/ML model using the model ID.

Additionally or alternatively, an AF 1660 (via NEF 1652)/MTLF 1662b can register an AI/ML model to the UPIC 610, which allocates the model ID and generates a tag to indicate the traffic rules that the model is related to. Specifically, the SMF 1646 can request AI/ML models using the traffic rules defined in [TS23501] as a tag. For example, the AI/ML models related to different traffic rules (e.g., PDR, PDI, FAR, MAR, URR, QER, BAR, SRR, PCC rules, and/or the like) can be tagged during model registration using the procedure shown by FIG. 13.

FIG. 13 shows an example procedure 1300 for UPIC model registration, ID allocation, and tag generation. Procedure 1300 is performed by a model provider 1305 and the UPIC 610. As examples, the model provider 1305 can be an AF 1660, NEF 1652, MTLF 1662b, an AI/ML model developer, vendor, and/or the other entity/entities providing the model and/or some other NF(s), including any of those mentioned herein. Procedure 1300 may operate as follows:
1) The model provider 1305 sends a model registration request to the UPIC 610 with model registration request information to register a set of AI/ML models for UPF traffic rules and/or for other purposes, such as any of those mentioned herein. Examples of the model registration request information include model training history, input/output descriptions, SW dependencies, HW dependencies, SW and/or HW requirements, training dataset(s), and/or other relevant/suitable information such as any of the information mentioned herein, in ‘155, and/or in ‘122.
2) The UPIC 610 allocates a model ID upon the ML model generation/registration and generates one or more corresponding tags. As examples, the model ID can be a number, string, URI, FQDN, and/or any other suitable ID and/or address that points to the model stored at a different endpoint (e.g., an NF endpoint, ADRF 1666, and/or the like). For UPF-related traffic rules, the UPIC 610 can tag individual ML models in the set of ML models with one or more rules or rulesets (e.g., DPR, PDR, PDI, PFD, UL classifier(s), FAR, QER, URR, BAR, MAR, SRR, PCC rules, and/or any expanded rules and/or the like). Additionally or alternatively, the UPIC 610 stores an model provider ID (e.g., an ID or NF ID of the model provider 1305).
3) The UPIC 610 sends a model registration response to the model provider 1305 to indicate the model registration is successful with the allocated model ID(s). In some examples, the model registration response includes other suitable information, such as any information mentioned herein.

### 4.3. UPIC AND RTIC INTERACTION OVER NI4

In various embodiments, an ML model can be provided to the RTIC 620 using a “pull” or “push” mode depending on the interaction among the SMF 1646, UPIC 610, and/or UPF 1648 (RTIC 620). In the “pull” mode, the RTIC 620 pulls the ML model from the UPIC 610. In the “push” mode, the UPIC 610 pushes the ML model to the RTIC 620. These two modes can co-exist in the RTIC 620 and UPIC 610 interaction for different AI/ML models, criteria, conditions, parameters, and/or traffic rules.

### 4.3.1. Pull Mode

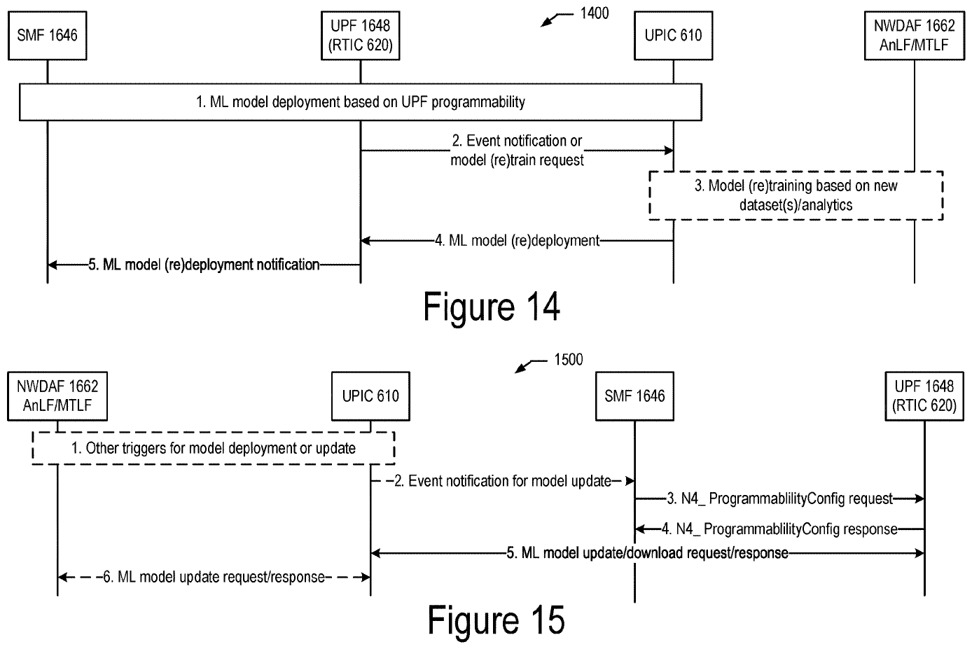

FIG. 14 shows an example pull mode procedure 1400 for ML model (re) training. In the pull mode, the RTIC 620 detects an event that indicates that an update to the current AI/ML model configuration is needed, detects one or more AI/ML model performance metrics (e.g., inference accuracy and/or the like) drop below predefined or configurable threshold(s). In some implementations, the RTIC 620 can be configured with event triggers to request new or alternative configurations about AI/ML models. Additionally or alternatively, the RTIC 620 can directly request a retrain of models with new or alternative dataset(s) if the model itself does not need to be updated but the parameters. Procedure 1400 may operate as follows.
1) The SMF 1646 deploys one or more ML models to the UPF 1648 based on its programmability as described herein, in ‘155, and/or in ‘122. Here, the SMF 1646 can send an ML model ID and/or UPIC ID (e.g., a URI, URL, FQDN, and/or some other ID or address, such as any of those discussed herein) to the RTIC 620 which can download the ML model from the UPIC 610 directly via the Ni4 interface. In some examples, the SMF 1646 also configures triggers, conditions, criteria, and/or the like in the RTIC 620 for notifying the UPIC 610 of the events, and/or request for a (re) training for the model in the UPIC 610 with a new or alternative dataset(s). The SMF 1646 may also include an NF endpoint where the new or alternative dataset(s) can be obtained for (re) training the ML model. In some examples, the SMF 1646 can configure the UPF 1648 for various event(s), such as when the RTIC 620 fails to classify a traffic flow with a certain accuracy, fails to identify an application flow based on profiling, and/or the like.
2) The RTIC 620 notifies the UPIC 610 about the events which triggers the UPIC 610 to (re) train the ML model.
3) Model (re) training based on new dataset(s)/analytics takes place. Here, the UPIC 610 can request (re) training of an ML model by requesting it to the MTLF 1662b with additional data or data ID (e.g., NF endpoint), which can be used to fetch the data in the AnLF 1662a.
4) The UPIC 610 sends a request to the RTIC 620 to deploy the updated ML model.
5) The RTIC 620 notifies the UPF 1648 (or SMF 1646) that a new ML model has been deployed.

### 4.3.2. Push Mode

FIG. 15 shows an example push mode procedure 1500 for ML model (re) training. The push mode describes that the UPIC 610 or SMF 1646 detects an event that requires an update to the current configuration in/at the RTIC 620. In some examples, the SMF 1646 or UPIC 610 can trigger the RTIC 620 (UPF 1648) to download or otherwise access the updated ML models.

Procedure 1500 may operate as follows:
1) The UPIC 610 subscribes to receive notifications from the NWDAF 1662. In particular, the UPIC 610 can subscribe to receive ML model status updates from the MTLF 1662b and/or data analytics notifications from the AnLF 1662a. This allows the UPIC 610 to get notified for a status changes, such as when an updated ML model is available and/or when analytics change. Additionally or alternatively, other triggers for model deployment or updates can be communicated between the NWDAF 1662 and the UPIC 610. The subscription request message can include the model ID of the relevant AI/ML model and/or other relevant information, such as any mentioned herein.
2) The UPIC 610 notifies the SMF 1646 of the event(s), assuming the SMF 1646 has previously subscribed to receive event notifications related to one or more ML models. For example, an event to be reported to the SMF 1646 can be a periodic ML model update, model performance metrics (e.g., precision, accuracy, and/or the like) falling below a predefined and/or configured threshold, and/or the like.
3) The SMF 1646 sends a N4_ProgrammabililtyConfig request to the UPF 1648 to request an ML model update. In this message, the SMF 1646 can request model (re) training, model (re)deployment, or model update with the related model IDs. This message can also include the ML model version information, new ID/addresses (e.g., URI and/or other ID(s)/adress(es)) for the updated ML model SE, new/alternative dataset(s) that can be used for a UPF 1648 (RTIC 620), and/or any other suitable information, such as any mentioned herein.
4) The UPF 1648 sends a N4_ProgrammabililtyConfig response to the SMF 1646 to indicate receipt of the ML model update request.
5) The UPF 1648 (RTIC 620) may send a request to download the ML model (or individual SEs) from the UPIC 610 for the updated model using the model ID, URI, URL, FQDN, and/or other ID(s)/network address(es). In some examples, the UPF 1648 (RTIC 620) may send a sub-model to the UPIC 610 for the purpose of federated learning and/or the like. Additionally or alternatively, the UPF 1648 (RTIC 620) can send one or more datasets, dataset ID(s), and/or analytics ID(s) with NF endpoint (e.g., ADRF 1666 and/or the like) where the data is stored to UPIC 610 for (re) training of the ML model. In the response, the UPIC 610 can send the requested updated or (re) trained ML model, or a location where the updated or (re) trained ML model can be obtained or otherwise accessed.
6) The UPIC 610 can use MTLF 1662b for (re) training of the model(s). If a data ID or analytics ID is sent in operation 5, the MTLF 1662b can retrieve the data from the NF endpoint (e.g., AnLF 1662a). In some examples, this step is optional.

### 5. Network, System, and Device Configurations and Arrangements

FIG. 16 depicts an example network architecture 1600. The network 1600 may operate in a manner consistent with 3GPP technical specifications for LTE or 5G/NR systems. However, the example embodiments are not limited in this regard and the described examples may apply to other networks that benefit from the principles described herein, such as future 3GPP systems, WiMAX systems, GSMA systems, WiFi systems, and/or the like.

The network 1600 includes a UE 1602, which is any mobile or non-mobile computing device designed to communicate with a RAN 1604 via an over-the-air connection. The UE 1602 is communicatively coupled with the RAN 1604 by a Uu interface, which may be applicable to both LTE and NR systems. Examples of the UE 1602 include, but are not limited to, a smartphone, tablet computer, wearable device (e.g., smart watch, fitness tracker, smart glasses, smart clothing/fabrics, head-mounted displays, smart shows, and/or the like), desktop computer, workstation, laptop computer, servers, in-vehicle infotainment system, in-car entertainment system, instrument cluster, head-up display (HUD) device, extended reality (XR) device (e.g., including augmented reality, virtual reality (VR), and/or mixed reality), onboard diagnostic device, dashtop mobile equipment, mobile data terminal, electronic engine management system, engine management system, electronic/engine control unit/module, embedded system, sensor, microcontroller, control module, networked appliance, machine-type communication device, machine-to-machine (M2M), Internet of Things (IoT) device, smart appliance, flying drone or unmanned aerial vehicle (UAV), terrestrial drone or autonomous vehicle, robot, electronic signage, single-board computer (SBC) (e.g., Raspberry Pi, Arduino, Intel Edison, and the like), plug computers, and/or any type of computing device such as any of those discussed herein. In some examples, the UE 1602 can include desktop computers. The UE 1602 may be the same or similar to any of the other UEs discussed herein such as, for example, UE 1902, hardware resources 2000, UE 1802, and/or the like.

In some examples, the network 1600 includes a set of UEs 1602 coupled directly with one another via a ProSe, PC5, SR5, sidelink (SL) interface, which involves communication between two or more UEs 1602 using 3GPP technology without traversing a network node. Here, the SL interface includes, for example, one or more SL logical channels (e.g., SL broadcast control channel (SBCCH), SL control channel (SCCH), and SL traffic channel (STCH)); one or more SL transport channels (e.g., SL shared channel (SL-SCH) and SL broadcast channel (SL-BCH)); and one or more SL physical channels (e.g., physical SL shared channel (PSSCH), physical SL control channel (PSCCH), physical SL feedback channel (PSFCH), physical SL broadcast channel (PSBCH), and/or the like). The UE 1602 may perform blind decoding attempts of SL channels/links according to the various examples herein.

In some examples, the UE 1602 can communicate with an AP 1606 via an over-the-air (OTA) connection. The AP 1606 manages a WLAN connection between the UE 1602 and the AP 1606, which is consistent with any IEEE 802 protocol (e.g., IEEE 802.11 and/or the like). Additionally, the UE 1602, RAN 1604, and AP 1606 may utilize cellular-WLAN aggregation/integration (e.g., LWA/LWIP), which may serve to offload some/all network traffic from the RAN 1604.

The RAN 1604 includes one or more network access nodes (NANs) 1614 (also referred to as “access network nodes”, “RAN nodes”, and/or the like). The NANs 1614 terminate air-interface(s) for the UE 1602 by providing access stratum protocols including RRC, PDCP, RLC, MAC, and PHY/L1 protocols. In this manner, the NANs 1614 enable data/voice connectivity between the CN 1640 and the UE 1602. The NANs 1614 may be a macrocell base station or a low power base station for providing femtocells, picocells or other like cells having smaller coverage areas, smaller user capacity, or higher bandwidth compared to macrocells; or some combination thereof. In these implementations, an NAN 1614 be referred to as a BS, gNB, RAN node, eNB, ng-eNB, NodeB, RSU, TRP, and the like. The RAN 1604 may have an NG-RAN architecture as discussed in 3GPP TS 38.401.

The RAN 1604 (or individual NANs 1614) may provide the air interface over a licensed spectrum or an unlicensed spectrum. To operate in the unlicensed spectrum, the nodes may use LAA, eLAA, and/or feLAA mechanisms based on CA technology with PCells/SCells. Prior to accessing the unlicensed spectrum, the nodes may perform medium/carrier-sensing operations based on, for example, a listen-before-talk (LBT) protocol.

The set of NANs 1614 are coupled with one another via respective Xn interfaces. The Xn interfaces, which may be separated into control/user plane interfaces in some examples, allow the NANs 1614 to communicate information related to handovers, data/context transfers, mobility, load management, interference coordination, and the like. The NANs 1614 manage one or more cells, cell groups, component carriers (CCs), and the like to provide the UE 1602 with an air interface for network access. The UE 1602 may be simultaneously connected with a set of cells provided by the same or different NANs 1614 of the RAN 1604 or a different RAN 1604. For example, the UE 1602 and RAN 1604 may use carrier aggregation (CA) to allow the UE 1602 to connect with a set of CCs, each corresponding to a primary cell (PCell) or secondary cell (SCell). The NG-RAN 1604 supports multi-radio DC (MR-DC) operation where a UE 1602 is configured to utilize radio resources provided by two distinct schedulers, located in at least two different NG-RAN nodes 1614 connected via a non-ideal backhaul, one NG-RAN node 1614 providing NR access and the other NG-RAN node 1614 providing either E-UTRA or NR access. Further details of MR-DC operation, including conditional PSCell addition (CPA) and conditional PSCell change (CPC), can be found in 3GPP TS 36.300 (“[TS36300]”), [TS38300], and 3GPP TS 37.340.

Individual UEs 1602 can be configured to measure or collect radio information, and provide the radio information to one or more NANs 1614. The radio information may be in the form of one or more measurement reports, and/or may include, for example, signal strength measurements, signal quality measurements, and/or the like. Each measurement report can be tagged with a timestamp and the location of the measurement (e.g., the UEs 1602 current location). For example, the UE 1602 can perform reference signal (RS) measurement and reporting procedures to provide the NW with information about the quality of one or more wireless channels and/or the communication media in general, and this information can be used to optimize various aspects of the communication system. Additionally or alternatively, individual UEs 1602 can be configured to measure or collect measurements for positioning, including DL, UL, and/or SL measurements for positioning, according to the various aspects discussed herein. As examples, the measurement and reporting procedures performed by the UE 1602 can include those discussed in 3GPP TS 38.211 (“[TS38211]”), 3GPP TS 38.212 (“[TS38212]”), 3GPP TS 38.213 (“[TS38213]”), 3GPP TS 38.214 (“[TS38214]”), 3GPP TS 38.215 (“[TS38215]”), 3GPP TS 38.101-1 (“[TS38101-1]”), 3GPP TS 38.104 (“[TS38104]”), 3GPP TS 38.113 (“[TS38113]”), 3GPP TS 38.133 (“[TS38133]”), 3GPP TS 38.331 (“[TS38331]”), and/or other the like. The physical signals and/or reference signals can include demodulation reference signals (DM-RS), phase-tracking reference signals (PT-RS), positioning reference signal (PRS), channel-state information reference signal (CSI-RS), synchronization signal block (SSB), primary synchronization signal (PSS), secondary synchronization signal (SSS), sounding reference signal (SRS), and/or the like. Examples of the measurements performed/collected by individual UEs 1602 and/or included in measurement reports can include one or more of the following: angle of arrival (AoA), accumulated delta range (ADR), additive white Gaussian noise (AWGN), average noise plus interference (ANPI), bandwidth (BW), bit error rate, bit error ratio (BER), block error rate (BLER), carrier-to-interference plus noise ratio (CINR), channel interference measurements, channel load measurements, channel occupancy ratio (CR), channel busy ratio (CBR), cell load, cross link interference (CLI), CLI-RSSI, CSI-RSRP, CSI-RSRQ, CSI-SINR, data rate, DL PRS-RSRP, DL PRS-RSRPP, DL RSCP, DL RSCPD, DL RSTD, DL timing drift, energy per bit to noise power density ratio (E_{b}/N₀), energy per chip to interference power density ratio (E_{c}/I₀), energy per chip to noise power density ratio (E_{c}/N₀), end-to-end (e2e) delay, GNSS carrier phase measurements, GNSS code measurements, GNSS timing of cell frames for UE positioning, GNSS carrier phase measurements, IEEE 802.11 WLAN RSSI, jitter, latency, network load, number of interrupts, out-of-order delivery, packet loss rate, packet error ratio (PER), packet reception rate (PRR), peak-to-average power ratio (PAPR), peak data rate, power histogram measurements, PSBCH-RSRP, PSSCH-RSRP, PSCCH-RSRP, received channel power indicator (RCPI), received interference power measurements, reference signal carrier phase (RSCP), RSCP difference (RSCPD), received signal code power, received signal to noise indicator (RSNI), received signal strength indicator (RSSI), reference signal time difference (RSTD), reference signal antenna relative phase (RSARP), reference signal received power (RSRP), RSRP per branch (RSRPB), reference signal received path power (RSRPP), reference signal received quality (RSRQ), reference signal (RS)-SINR, round trip time (RTT), (UE and/or RAN node) Rx-Tx measurements, (UE and/or RAN node) Rx-Tx time difference subframe offset, secondary synchronization signal (SSS) transmit power, SFN and frame timing difference (SFTD), signal-to-noise ratio (SNR), signal-to-noise and interference ratio (SINR), signal-plus-noise-plus-distortion to noise-plus-distortion (SINAD) ratio, SL AoA, SL CR, SL CBR, SL PRS-CR, SL PRS-CBR, SL PRS-RSRP, SL PRS-RSRPP, SL-RSRP, SL-RSRPP, SL RSSI, SL PRS-RSSI, SL-RSTD, SL Rx-Tx measurements, SL RTOA, SS-RSARP, SS-RSRP, SS-RSRQ, SS-SINR, SS-RSRPB, station (STA) statistics, transmission power, thermal noise power measurements, time domain channel property (TDCP), timing advance, UL AoA, UL RSCP, UL SRS-RSRP, UL SRS-RSRPP, UL RTOA, and/or other like measurements. Other measurements may be additionally or alternatively used, such as those discussed in [TS36214], [TS38215], 3GPP TS 38.314 (“[TS38314]”), 3GPP TS 28.552 (“[TS28552]”), 3GPP TS 32.425 (“[TS32425]”), IEEE 802.11, and/or the like. Additionally or alternatively, any of the aforementioned measurements (or combination of measurements) may be collected by one or more NANs 1614 and/or other network nodes.

In some examples, a UE 1602 can measure phyiscal (e.g., DL, UL, and/or SL) signals using its Rx capabilities, such as by employing its radiofrequency (RF) frontend, digital baseband processing, and measurement algorithms (and using a measurement configuration) to gather information about the signal's characteristics. In these examples, the UE's 1602 RF frontend receives signals transmitted by other network nodes (e.g., NANs 1614 and/or other UEs 1602 participating in the SL communication). The received signal is downconverted to baseband or an intermediate frequency suitable for digital processing. The downconverted signal is sampled and converted from analog to digital by the UE's 1602 analog-to-digital conversion (ADC) circuitry, resulting in a digital representation of the received signal. The digital signal is processed by the UE's baseband processors (see e.g., processors 2010 of FIG. 20) including tasks, such as filtering, synchronization, equalization, demodulation, and/or the like to extract useful information from the received signal. The UE 1602 performs channel estimation by estimating various channel characteristics (e.g., path loss, fading, interference, and/or the like) based on the received signal and/or reference signals transmitted by neighboring UEs 1602 and/or NAN(s) 1614. Using the estimated channel characteristics, the UE 1602 calculates measurements, such as any of the measurements discussed herein, and/or other metrics that characterize the quality of the received signals. The UE 1602 may then report the measured parameters to the NW or neighboring UEs 1602 using configured resources and/or as otherwise discussed herein.

As alluded to previously, the NG-RAN 1604 provides a 5G-NR air interface (e.g., Uu interface), which may have the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FRI bands that include sub-6 GHz bands or FR2 bands that include bands from 24.25 GHz to 52.6 GHz. The 5G-NR air interface may include an SSB that is an area of a downlink resource grid that includes PSS/SSS/PBCH. The 5G-NR air interface may utilize BWPs for various purposes. For example, BWP can be used for dynamic adaptation of the SCS. For example, the UE 1602 can be configured with multiple BWPs where each BWP configuration has a different SCS. When a BWP change is indicated to the UE 1602, the SCS of the transmission is changed as well. Another use case example of BWP is related to power saving. In particular, multiple BWPs can be configured for the UE 1602 with different amount of frequency resources (e.g., PRBs) to support data transmission under different traffic loading scenarios. A BWP containing a smaller number of PRBs can be used for data transmission with small traffic load while allowing power saving at the UE 1602 and in some cases at the gNB 1614a. A BWP containing a larger number of PRBs can be used for scenarios with higher traffic load.

The NG-RAN 1604 may utilize one or more positioning methods in order to determine the position of a UE 1602. Positioning the UE 1602 (e.g., determining the position of a UE 1602) involves two main operations: signal measurements and position estimate and optional velocity computation based on the measurements. The signal measurements may be made by the UE 1602 and/or by the serving ng-eNB 1614b or gNB 1614a. The basic signals measured for terrestrial position methods are typically LTE or NR radio transmissions; however, other methods may make use of other transmissions, such as general radio navigation signals including those from Global Navigation Satellites Systems (GNSSs). The positioning function is not limited to a single method or measurement, and other methods and measurements that are available and appropriate can be used to meet the service needs of the location service (LCS) client 1680. This additional information could include readily available E-UTRAN or NG-RAN measurements. The position estimate computation may be made by the UE 1602 and/or by the LMF 1670. UE positioning methods using SL may be used to obtain absolute position, relative position, or ranging information when the UE 1602 is inside or outside NG-RAN coverage.

The RAN 1604 is communicatively coupled to CN 1640 that includes network elements and/or network functions (NFs) to provide various functions to support data and telecommunications services to customers/subscribers (e.g., UE 1602). The components of the CN 1640 may be implemented in one physical node or separate physical nodes. In some examples, NFV may be utilized to virtualize any or all of the functions provided by the network elements of the CN 1640 onto physical compute/storage resources in servers, switches, and the like. A logical instantiation of the CN 1640 may be referred to as a network slice, and a logical instantiation of a portion of the CN 1640 may be referred to as a network sub-slice.

In the example of FIG. 16, the CN 1640 is a 5GC 1640 including an Authentication Server Function (AUSF) 1642, Access and Mobility Management Function (AMF) 1644, Session Management Function (SMF) 1646, User Plane Function (UPF) 1648, Network Slice Selection Function (NSSF) 1650, Network Exposure Function (NEF) 1652, Network Repository Function (NRF) 1654, Policy Control Function (PCF) 1656, Unified Data Management (UDM) 1658, Unified Data Repository (UDR), Application Function (AF) 1660, and Network Data Analytics Function (NWDAF) 1662 coupled with one another over various interfaces as shown. Various aspects of the various NFs in the 5GC 1640 are discussed in detail herein. Aspects of any of the NFs shown by FIG. 16 not discussed herein are discussed in detail in ‘155, ‘122, ‘609, as well as [TS23501], among many other 3GPP standards/specifications. Although not shown by FIG. 16, the system 1600 may also include NFs that are not shown such as, for example, any of those discussed in [TS23501] and/or other 3GPP standards/specifications.

The NWDAF 1662 is an NF capable of collecting data from UEs 1602, other NF(s) in 5GC 1640 (e.g., AMF 1644, SMF 1646, UPF 1648, PCF 1656, UDM 1658, Network Slice Admission Control Function (NSACF), AF 1660 (directly and/or via the NEF 1652)), OAM entities/functions (e.g., OAM 405), external AFs 1660, DNs 1636, server(s) 1638, cloud computing services, edge compute nodes and/or edge networks, and/or other entities/elements that can be used for analytics.

The NWDAF 1662 includes one or more of the following functionalities: support data collection from NFs and AFs 1660; support data collection from OAM; NWDAF service registration and metadata exposure to NFs and AFs 1660; support analytics information provisioning to NFs and AFs 1660; support ML model training and provisioning to NWDAF(s) 1662 (e.g., those containing analytics logical function). Some or all of the NWDAF functionalities can be supported in a single instance of an NWDAF 1662. The NWDAF 1662 also includes an analytics reporting capability, which comprises means that allow discovery of the type of analytics that can be consumed by an external party and/or the request for consumption of analytics information generated by the NWDAF 1662. The NWDAF 1662 can collect data from NF(s) and/or other entities/elements/functions over an Nnf service-based interface associated with the NF(s) and/or other entities/elements/functions. The NWDAF 1662 belongs to the same PLMN as the NF that provides the data. The Nnf interface is defined for the NWDAF 1662 to request subscription to data delivery for a particular context, cancel subscription to data delivery, and request a specific report of data for a particular context. The 5GS architecture also allows the NWDAF 1662 to retrieve management data from an OAM entity by invoking OAM services.

The NWDAF 1662 interacts with different entities for different purposes, such as one or more of the following: data collection based on subscription to events provided by AMF 1644, SMF 1646, PCF 1656, UDM 1658, NSACF, AF 1660 (directly or via NEF 1652) and OAM; analytics and data collection using the DCCF 1663; retrieval of information from data repositories (e.g., UDR 1659 via UDM 1658 for subscriber-related information); data collection of location information from LCS system; storage and retrieval of information from ADRF 1666; analytics and data collection from MFAF 1665; retrieval of information about NFs (e.g., from NRF 1654 for NF-related information); on-demand provision of analytics to consumers, as specified in clause 6 of [TS23288]; provision of bulked data related to analytics ID(s); provision of accuracy information about analytics ID(s); and/or provision of ML model accuracy information and/or ML model accuracy degradation about one or more ML models. NWDAF discovery and selection procedures are discussed in [TS23501] § 6.3.13 and [TS23288] § 5.2.

A single instance or multiple instances of NWDAF 1662 may be deployed in a PLMN. In some implementations, NWDAF instance(s) 1662 can be collocated with other 5GS NFs. If multiple NWDAF 1662 instances are deployed, the architecture supports deploying the NWDAF 1662 as a central NF, as a collection of distributed NFs, or as a combination of both. If multiple NWDAF 1662 instances are deployed, an NWDAF 1662 can act as an aggregate point (e.g., aggregator NWDAF 1662) and collect analytics information from other NWDAFs 1662, which may have different serving areas, to produce the aggregated analytics (e.g., per analytics ID), possibly with analytics generated by itself. When multiple NWDAFs 1662 exist, not all of them need to be able to provide the same type of analytics results. For example, some of the NWDAFs 1662 can be specialized in providing certain types of analytics.

Network data analytics are identified by analytics ID and related information discussed in [TS23288]. The NWDAF 1662 can produce multiple analytics related to various services, which can be consumed by NFs, such as any of the NFs mentioned herein. An analytics ID information element (IE) is used to identify the type of supported analytics that NWDAF 1662 can generate. When a consumer of NWDAF analytics (through analytics subscription or analytics request message(s)) may provide any combination of analytics IDs (e.g., in a list of analytics ID(s) parameter/IE) to identify the requested analytics to be provided by the NWDAF 1662. Additionally, analytics filter information can be provided to the NWDAF 1662 in the analytics subscription/request, which indicates the conditions to be fulfilled for reporting analytics information. The analytics filter information can include a set of optional parameter types and values that enables selection of the type of analytics information being requested. Additionally or alternatively, the analytics subscription/request can include a target of analytics reporting (e.g., object(s) for which analytics information is requested), notification target address, analytics reporting information/parameters (e.g., event-based reporting, periodic reporting, reporting frequency, reporting thresholds, matching criteria and/or matching direction, acceptable deviations, update rate, refreshing rate, and/or the like), analytics target period (e.g., including for historical/past and/or future (to be collected) analytics), time window (e.g., time interval for historical analytics), time when analytics information is needed, updated analytics and/or update rate, refreshing rate, sensing service parameters (e.g., object classifications and/or object types to be detected, object tracking information, object shape identification, object mobility information (e.g., range, speed, heading, angular estimates, and/or the like), detection angle, sensing use case/application, and/or any other sensing service information, such as any of those discussed herein). Additional aspects of the analytics subscription/requests and analytics exposure parameters is/are discussed in [TS23288].

Different NWDAF instances 1662 may be present in the 5GC 1640, with possible specializations per type of analytics (and/or per analytics ID). The capabilities of an NWDAF instance 1662 are described in the NWDAF profile stored in the NRF 1654. which is described in more detail infra. In a multiple NWDAF deployment scenario, an NWDAF instance 1662 may be specialized to provide analytics for one or more analytics IDs. Each of the NWDAF instances 1662 may serve a certain area of interest (AoI), one or more tracking area identities (TAI(s)), service area(s), registration area(s), DN name(s) (DNN(s)), local DNN(s), DN access ID(s) (DNAI(s)), and/or some other predefined or configured region/area, service, application, or other entity/element. Multiple NWDAFs 1662 may collectively serve the particular analytics ID(s). An NWDAF 1662 may have the capability to support the aggregation of analytics (e.g., per analytics ID) received from other NWDAFs 1662, possibly with analytics generated by itself.

The NWDAF 1662 may contain an analytics logical function (AnLF) 1662a and/or a model training logical function (MTLF) 1662b (see e.g., FIG. 17). The NWDAF 1662 can contain only an MTLF 1662b, only an AnLF 1662a, or both logical functions. The 5GS architecture allows an NWDAF containing an AnLF 1662a (referred to herein as “NWDAF-ANLF AnLF 1662a” and/or the like) to use trained ML model provisioning services from the same or different NWDAF containing an MTLF 1662b (also referred to herein as “NWDAF-MTLF 1662b”). The Nnwdaf interface is used by the NWDAF-AnLF 1662a to request and subscribe to trained ML model provisioning services provided by the NWDAF-MTLF 1662b. The NWDAF 1662 provides an Nnwdaf_MLModelProvision service enables an NF service consumer to receive a notification when an ML model matching the subscription parameters becomes available in the NWDAF-MTLF 1662b (see e.g., clause 7.5 of [TS23288]). The NWDAF 1662 provides an Nnwdaf_MLModelInfo service that enables an NF service consumer to request and get ML Model information from the NWDAF-MTLF 1662b (see e.g., clause 7.6 of [TS23288]).

The AnLF 1662a is a logical function in the NWDAF 1662 that performs inference, derives analytics information (e.g., derives statistics, inferences, and/or predictions based on analytics consumer requests) and exposes analytics services (e.g., Nnwdaf_AnalyticsSubscription or Nnwdaf_AnalyticsInfo). In some implementations, the AnLF 1662a is an AI/ML inference function contained by an NWDAF 1662 In various embodiments, the AnLF 1662a can be modelled by NRM for AI/ML inference management as discussed herein. Analytics information are either statistical information of the past events, or predictive information (e.g., generating predictions/inferences using one or more AI/ML models and/or the like). The MTLF 1662b is a logical function in the NWDAF 1662 that trains AI/ML models and exposes new training services (e.g., providing trained ML model) as defined in [TS23288] §§ 7.5 and 7.6.

To guarantee the accuracy of analytics output for an analytics ID, based on the UE abnormal behavior analytics from itself and/or other NWDAFs 1662 including abnormal UE list and the observed time window, the NWDAF 1662 is to detect and may delete the input data from the abnormal UE(s) 1602 and then may generate a new ML model and/or analytics outputs for the analytics ID without the input data related to abnormal UE list during the observed time window and then send/update the ML model information and/or analytics outputs to the subscribed NWDAF service consumer.

In order to support NFs to discover and select an NWDAF-MTLF 1662b, NWDAF-AnLF 1662a, or both, that is able to provide the required service (e.g., analytics exposure, AI/ML services (e.g., MLT, ML model provisioning, model testing, and/or the like), sensing services, communication services, and/or any other service(s) including any of those discussed herein) for the required type of analytics, each NWDAF instance 1662 should provide the list of supported analytics ID(s), possibly per supported service (e.g., AI/ML services, analytics exposure/services, sensing services, and/or any other service(s), including any of those mentioned herein), when registering to the NRF 1654, in addition to other NRF registration elements of the NF profile. NFs requiring the discovery of an NWDAF instance 1662 that provides support for some specific service(s) for a specific type of analytics may query the NRF 1654 for NWDAFs 1662 supporting the required service(s) and the required analytics ID(s).

Since multiple NWDAF 1662 instances may be deployed in a network, an NF service consumer can utilize the NRF 1654 to discover NWDAF 1662 instance(s) unless NWDAF information is available by other means (e.g., locally configured on NF service consumers). NF service consumers may make an additional query to the UDM 1658, when supported. An NWDAF selection function in an NF service consumer selects an NWDAF instance 1662 (or an NWDAF-MTLF instance 1662b and/or NWDAF-AnLF instance 1662a) based on the available NWDAF 1662 instances, a list of supported analytics ID(s) (e.g., possibly per supported service) stored/from an NRF 1654, NWDAF capabilities (e.g., analytics aggregation capability, analytics metadata provisioning capability, ML model training capabilities, ML model deployment capabilities, and/or the like), and/or other NRF 1654 registration elements of the NF profile. Additional and/or alternative aspects of NWDAF 1662 functionality are defined in 3GPP TS 23.288 (“[TS23288]”).

The SMF 1646 is responsible for SM (e.g., session establishment, tunnel management between UPF 1648 and NAN 1614); UE IP address allocation and management (including optional authorization); selection and control of UP function; configuring traffic steering at UPF 1648 to route traffic to proper destination; termination of interfaces toward policy control functions; controlling part of policy enforcement, charging, and QoS; lawful intercept (for SM events and interface to LI system); termination of SM parts of NAS messages; DL data notification; initiating AN specific SM information, sent via AMF 1644 over N₂ to NAN 1614; and determining SSC mode of a session. SM refers to management of a PDU session, and a PDU session or “session” refers to a PDU connectivity service that provides or enables the exchange of PDUs between the UE 1602 and the DN 1636. The SMF 1646 may also include the following functionalities to support edge computing enhancements (see e.g., [TS23548]): selection of EASDF 1661 and provision of its address to the UE as the DNS server for the PDU session; usage of EASDF 1661 services as defined in [TS23548]; and for supporting the application layer architecture defined in [TS23558], provision and updates of ECS address configuration information to the UE. Discovery and selection procedures for EASDFs 1661 is discussed in [TS23501] § 6.3.23.

The UPF 1648 is an interconnect point between the mobile infrastructure and the DN 1636, and is a Protocol Data Unit (PDU) session anchor point for providing mobility within and between RANs 1604, including sending one or more end marker packets to individual NANs 1614. Additionally or alternatively, the UPF 1648 performs packet routing and forwarding, including performing the role of an uplink classifier (UL-CL) (e.g., by directing flows to specific DNs 1636 based on traffic matching filters and/or the like) and performing the role of a branching point, when acting as an Intermediate UPF (I-UPF) 1648 multi-homed to one or more PDU session anchors (PSAs). Additionally or alternatively, the UPF 1648 performs application detection using service data flow (SDF) traffic filter templates and/or PFDs received from the SMF 1646. In some examples, the PFDs may be 3-tuple (e.g., protocol, server-side IP address, and port number) PFDs or 5-tuple PFDs. Additionally or alternatively, the UPF 1648 performs per-flow QoS handling, including transport level packet marking for UL and DL, rate limiting and reflective QoS (DSCP) marking on the DL, and/or the like. Additionally or alternatively, the UPF 1648 performs traffic usage reporting for billing and the Lawful Intercept (LI) collector interface.

In various implementations, the UPF 1648 includes the following functionality, wherein some or all of the following UPF functionalities may be supported in a single instance of a UPF 1648: acts as an anchor point for intra-RAT and inter-RAT mobility when applicable; allocation of UE network address/prefix (e.g., IP address and/or the like), if supported, in response to SMF request; external PDU session point of interconnect to DN 1636; packet routing and forwarding (e.g., support of uplink classifier to route traffic flows to an instance of a DN 1636, support of branching point to support multi-homed PDU session(s), support of traffic forwarding within a 5G VN group (e.g., UPF local switching, via N₆, via N₁₉, and/or the like); packet inspection (e.g., Application detection based on service data flow template and the optional PFDs received from the SMF in addition); UP part of policy rule enforcement (e.g., gating, redirection, traffic steering); lawful intercept (UP collection); traffic usage reporting; QoS handling for user plane, e.g., UL/DL rate enforcement, Reflective QoS marking in DL; UL traffic verification (e.g., SDF to QoS Flow mapping); transport level packet marking in the UL and DL; DL packet buffering and downlink data notification triggering; sending and forwarding of one or more “end marker” to the source NG-RAN node 1614; functionality to respond to Address Resolution Protocol (ARP) requests and/or IPv6 neighbor solicitation requests based on local cache information for the Ethernet PDUs. The UPF responds to the ARP and/or the IPV6 Neighbour Solicitation Request by providing the MAC address corresponding to the IP address sent in the request; packet duplication in downlink direction and elimination in uplink direction in GTP—U layer; network-side time sensitive networking (TSN) translator (NW-TT) functionality; high latency communication; access traffic steering, switching, and splitting (ATSSS) functionality to steer the MA PDU session traffic; inter-PLMN UP Security (IPUPS) functionality; event exposure including exposure of network information (e.g., QoS monitoring information as specified in [TS23501] § 5.8.2.18, and events as specified in [TS23502] § 5.2.26.2), exposure of data collected for analytics (see e.g., [TS23502] § 5.2.26.2), and exposure of time sensitive communication (TSC) management information (see e.g., [TS23501] § 5.8.5.14); exposure of the UE information (e.g., UE IP address translation information as specified in [TS23502] § 5.2.26.3 and [TS23502] § 4.15.10 if network address translation (NAT) functionality of the UE IP address is deployed within UPF 1648); and support PDU set handling as defined in [TS23501] § 5.37.5. In some examples, not all of the UPF functionalities are required to be supported in an instance of UPF 1648 of a Network Slice.

The NEF 1652 securely exposes services and capabilities provided by 3GPP NFs for third party, internal exposure/re-exposure, AFs 1660, edge computing networks/frameworks, and the like. In such examples, the NEF 1652 may authenticate, authorize, or throttle the AFs 1660. The NEF 1652 stores/retrieves information as structured data using the Nudr interface to a Unified Data Repository (UDR). The NEF 1652 also translates information exchanged with the AF 1660 and information exchanged with internal NFs. For example, the NEF 1652 may translate between an AF-Service-Identifier and an internal 5GC information, such as DNN, S-NSSAI, as described in [TS23501] § 5.6.7. In particular, the NEF 1652 handles masking of network and user sensitive information to external AF's 1660 according to the network policy. The NEF 1652 also receives information from other NFs based on exposed capabilities of other NFs. This information may be stored at the NEF 1652 as structured data, or at a data storage NF using standardized interfaces. The stored information can then be re-exposed by the NEF 1652 to other NFs and AFs, or used for other purposes such as analytics. For example, NWDAF analytics may be securely exposed by the NEF 1652 for external party, as specified in [TS23288]. Furthermore, data provided by an external party may be collected by the NWDAF 1662 via the NEF 1652 for analytics generation purpose. The NEF 1652 handles and forwards requests and notifications between the NWDAF 1662 and AF(s) 1660, as specified in [TS23288]. In some examples, the NEF 1652 can provide interface(s) to one or more edge compute nodes 1638, which can be used to process wireless connections with the RAN 1614 and/or to offload tasks to the edge compute nodes 1638.

The NRF 1654 supports service discovery functions, receives NF discovery requests from NF instances, and provides information of the discovered NF instances to the requesting NF instances. The NRF 1654 also maintains NF profiles of available NF instances and their supported services. The NF profile of NF instance maintained in the NRF 1654 includes the following information: NF instance ID; NF type; PLMN ID in the case of PLMN, PLMN ID+NID in the case of SNPN; Network Slice related Identifier(s) (e.g., S-NSSAI, NSI ID); an NF's network address(es) (e.g., FQDN, IP address, and/or the like), NF capacity information, NF priority information (e.g., for AMF selection), NF set ID, NF service set ID of the NF service instance; NF specific service authorization information; names of supported services, if applicable; endpoint address(es) of instance(s) of each supported service; identification of stored data/information (e.g., for UDR profile and/or other NF profiles); other service parameter(s) (e.g., DNN or DNN list, LADN DNN or LADN DNN list, notification endpoint for each type of notification that the NF service is interested in receiving, and/or the like); location information for the NF instance (e.g., geographical location, data center, and/or the like); TAI(s); NF load information; Routing Indicator, Home Network Public Key identifier, for UDM 1658 and AUSF 1642; for UDM 1658, AUSF 1642, and NSSAAF in the case of access to an SNPN using credentials owned by a Credentials Holder with AAA Server, identification of Credentials Holder (e.g., the realm of the Network Specific Identifier based SUPI); for UDM 1658 and AUSF 1642, and if UDM 1658/AUSF 1642 is used for access to an SNPN using credentials owned by a Credentials Holder, identification of Credentials Holder (e.g., the realm if network specific identifier based SUPI is used or the MCC and MNC if IMSI based SUPI is used); for AUSF 1642 and NSSAAF in the case of SNPN Onboarding using a DCS with AAA server, identification of DCS (e.g., the realm of the Network Specific Identifier based SUPI); for UDM 1658 and AUSF 1642, and if UDM 1658/AUSF 1642 is used as DCS in the case of SNPN Onboarding, identification of DCS ((e.g., the realm if Network Specific Identifier based SUPI, or the MCC and MNC if IMSI based SUPI); one or more GUAMI(s), in the case of AMF 1644; for the UPF 1648 (see e.g., [TS23502] § 5.2.7.2.2); UDM Group ID, range(s) of SUPIs, range(s) of GPSIs, range(s) of internal group identifiers, range(s) of external group identifiers for UDM 1658; UDR Group ID, range(s) of SUPIs, range(s) of GPSIs, range(s) of external group identifiers for UDR; AUSF Group ID, range(s) of SUPIs for AUSF 1642; PCF Group ID, range(s) of SUPIs for PCF 1656; HSS Group ID, set(s) of IMPIs, set(s) of IMPU, set(s) of IMSIs, set(s) of PSIs, set(s) of MSISDN for HSS; event ID(s) supported by AFs 1660, in the case of NEF 1652; event Exposure service supported event ID(s) by UPF 1648; application identifier(s) supported by AFs 1660, in the case of NEF 1652; range(s) of external identifiers, or range(s) of external group identifiers, or the domain names served by the NEF, in the case of NEF 1652 (e.g., used when the NEF 1652exposes AF information for analytics purpose as detailed in [TS23288]; additionally the NRF 1654 may store a mapping between UDM Group ID and SUPI(s), UDR Group ID and SUPI(s), AUSF Group ID and SUPI(s) and PCF Group ID and SUPI(s), to enable discovery of UDM 1658, UDR, AUSF 1642 and PCF 1656 using SUPI, SUPI ranges as specified in [TS23501] § 6.3, and/or interact with UDR to resolve the UDM Group ID/UDR Group ID/AUSF Group ID/PCF Group ID based on UE identity (e.g., SUPI)); IP domain list (see e.g., [TS29510] § 6.1.6.2.21), Range(s) of (UE) IPv4 addresses or Range(s) of (UE) IPV6 prefixes, Range(s) of SUPIs or Range(s) of GPSIs or a BSF Group ID, in the case of BSF; SCP Domain the NF belongs to; DCCF Serving Area information, NF types of the data sources, NF Set IDs of the data sources, if available, in the case of DCCF 1663; supported DNAI list, in the case of SMF 1646; for SNPN, capability to support SNPN Onboarding in the case of AMF and capability to support User Plane Remote Provisioning in the case of SMF 1646; IP address range, DNAI for UPF 1648; additional V2X related NF profile parameters are defined in 3GPP TS 23.287; additional ProSe related NF profile parameters are defined in 3GPP TS 23.304; additional MBS related NF profile parameters are defined in 3GPP TS 23.247; additional UAS related NF profile parameters are defined in 3GPP TS 23.256; among many others discussed in [TS23501]. In some examples, service authorization information provided by an OAM system is also included in the NF profile in the case that, for example, an NF instance has an exceptional service authorization information.

For NWDAF 1662, the NF profile includes: supported analytics ID(s), possibly per service, NWDAF serving area information (e.g., a list of TAIs for which the NWDAF can provide services and/or data), Supported Analytics Delay per Analytics ID (if available), NF types of the NF data sources, NF Set IDs of the NF data sources, if available, analytics aggregation capability (if available), analytics metadata provisioning capability (if available), ML model filter information parameters S-NSSAI(s) and area(s) of interest for the trained ML model(s) per analytics ID(s) (if available), federated learning (FL) capability type (e.g., FL server or FL client, if available), Time interval supporting FL (if available). The NWDAF's 1662 Serving Area information is common to all its supported analytics IDs. The analytics IDs supported by the NWDAF 1662 may be associated with a supported analytics delay, for example, the analytics report can be generated with a time (including data collection delay and inference delay) in less than or equal to the supported analytics delay. The determination of supported analytics delay, and how the NWDAF 1662 avoid updating its Supported Analytics Delay in NRF frequently may be NWDAF-implementation specific.

The PCF 1656 provides policy rules to control plane functions to enforce them, and may also support unified policy framework to govern network behavior. The PCF 1656 may also implement a front end to access subscription information relevant for policy decisions in a UDR 1659 of the UDM 1658. In addition to communicating with functions over reference points as shown, the PCF 1656 exhibit an Npcf service-based interface.

The UDM 1658handles subscription-related information to support the network entities’ handling of communication sessions, and stores subscription data of UE 1602. For example, subscription data may be communicated via an N8 reference point between the UDM 1658 and the AMF 1644. The UDM 1658 may include two parts, an application front end and a UDR. The UDR may store subscription data and policy data for the UDM 1658 and the PCF 1656, and/or structured data for exposure and application data (including PFDs for application detection, application request information for multiple UEs 1602) for the NEF 1652. The Nudr service-based interface may be exhibited by the UDR to allow the UDM 1658, PCF 1656, and NEF 1652 to access a particular set of the stored data, as well as to read, update (e.g., add, modify), delete, and subscribe to notification of relevant data changes in the UDR. The UDM 1658 may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 1658 may exhibit the Nudm service-based interface.

The AF 1660 provides application influence on traffic routing, provides access to NEF 1652, and interacts with the policy framework for policy control. The AF 1660 may influence UPF 1648 (re) selection and traffic routing. Based on operator deployment, when AF 1660 is considered to be a trusted entity, the network operator may permit AF 1660 to interact directly with relevant NFs. In some implementations, the AF 1660 is used for edge computing implementations. An NF that needs to collect data from an AF 1660 may subscribe/unsubscribe to notifications regarding data collected from an AF 1660, either directly from the AF 1660 or via NEF 1652. The data collected from an AF 1660 is used as input for analytics by the NWDAF 1662. The details for the data collected from an AF 1660 as well as interactions between NEF 1652, AF 1660 and NWDAF 1662 are described in [TS23288].

The data network (DN) 1636, at least in some examples, is a network hosting data-centric services such as, for example, operator services, the internet, third-party services, or enterprise networks. In some examples, the DN 1636 includes one or more service networks that belong to an operator or third party, which are offered as a service to a client or UE 1602. Additionally or alternatively, the DN 1636 is provided by one or more servers including, for example, application (app)/content server 1638, edge servers and/or edge compute nodes, cloud computing services, and/or the like. The DN 1636 may be an operator external public, a private packet data network (PDN), or an intra-operator PDN, for example, for provision of IMS services. In this example, the app server 1638 can be coupled to an IMS via an S-CSCF or the I-CSCF. In some implementations, the DN 1636 may represent one or more local area DNs (LADNs), which are DNs 1636 (or DN names (DNNs)) that is/are accessible by a UE 1602 in one or more specific areas. Outside of these specific areas, the UE 1602 is not able to access the LADN/DN 1636. Additionally or alternatively, the DN 1636 may be an edge DN 1636, which is a (local) DN that supports the architecture for enabling edge applications. In these examples, the app server 1638 may represent the physical hardware systems/devices providing app server functionality and/or the application software resident in the cloud or at an edge compute node that performs server function(s). In some examples, the app/content server 1638 provides an edge hosting environment that provides support required for Edge Application Server's execution.

In some examples, the 5GS can use one or more edge compute nodes to provide an interface and offload processing of wireless communication traffic. In these examples, the edge compute nodes may be included in, or co-located with one or more RANs 1604 or RAN nodes 1614. For example, the edge compute nodes can provide a connection between the RAN 1604 and UPF 1648 in the 5GC 1640. The edge compute nodes can use one or more NFV instances instantiated on virtualization infrastructure within the edge compute nodes to process wireless connections to and from the RAN 1604 and UPF 1648. The edge compute nodes may include or be part of an edge system that employs one or more edge computing technologies (ECTs) (also referred to as an “edge computing framework” or the like). The edge compute nodes may also be referred to as “edge hosts” or “edge servers.” The edge system includes a collection of edge servers and edge management systems (not shown) necessary to run edge computing applications within an operator network or a subset of an operator network. The edge servers are physical computer systems that may include an edge platform and/or virtualization infrastructure, and provide compute, storage, and network resources to edge computing applications. Each of the edge servers are disposed at an edge of a corresponding access network, and are arranged to provide computing resources and/or various services (e.g., computational task and/or workload offloading, cloud-computing capabilities, IT services, and other like resources and/or services as discussed herein) in relatively close proximity to UEs 1602. The VI of the edge compute nodes provide virtualized environments and virtualized resources for the edge hosts, and the edge computing applications may run as VMs and/or application containers on top of the VI. Examples of the edge computing frameworks/ECTs and services deployment examples that can be used are discussed in ‘155, ‘122, and ‘609.

The interfaces of the 5GC 1640 include reference points and service-based interfaces. A reference point, at least in some examples, is a point at the conjunction of two non-overlapping functional groups, elements, or entities. The reference points in the 5GC 1640 include: N1, N2, N3, N4, N5, N6, N7, N8, N9, N10, N11, N12, N13, N14 (between two AMFs 1644; not shown), N15, N16, and N22. Other reference points not shown in FIG. 16 can also be used, such as any of those discussed in [TS23501]. The service-based representation of FIG. 16 represents NFs within the control plane that enable other authorized NFs to access their services. A service-based interface (SBI), at least in some examples, is an interface over which an NF can access the services of one or more other NFs. In some implementations, the service-based interfaces are API-based interfaces (e.g., HTTP/2, RESTful, SOAP, and/or any other API or web service) that can be used by an NF to call or invoke a particular service or service operation. The SBIs in the 5GC 1640 include: Namf, Nsmf, Nnef, Npcf, Nudm, Naf, Nnrf, Nnssf, Nausf. Other service-based interfaces (e.g., Nudr, N5g-eir, and Nudsf) not shown in FIG. 16 can also be used, such as any of those discussed in [TS23501].

FIG. 17 depicts various example NWDAF frameworks/architectures, including an example data collection architecture 1701 using data collection coordination. The data collection architecture includes an NWDAF 1662, a Data Collection Coordination Function (DCCF) 1663, a messaging framework 1664 that includes a Messaging Framework Adaptor Function (MFAF) 1665, and a network node/NF 1750, which can be or include an NRF 1654, UDM 1658, and/or a Binding Support Function (BSF) (see e.g., [TS23502]). Various DCCF services and various MFAF services are discussed in [TS23288].

The NWDAF 1662 is communicatively coupled with the MFAF 1665 via an Nmfaf interface, and communicatively coupled with the DCCF 1663 via an Ndccf interface. The Ndccf interface is defined for the NWDAF 1662 to support subscription request(s) for data delivery from a DCCF 1663, to cancel subscription to data delivery, and to request a specific report of data. If the data is not already being collected, the DCCF 1663 requests the data from the Data Source (e.g., any NF) using Nnf services (e.g., via the Nnf interface). The DCCF 1663 may collect the data and deliver it to the NWDAF 1662 (e.g., via the Ndccf interface), or the DCCF 1663 may rely on the messaging framework 1664 to collect data from the NF and deliver it to the NWDAF 1662. The DCCF 1663 is communicatively coupled with the MFAF 1665 via an Nmfaf interface.

FIG. 17 also depicts an example network data analytics exposure architecture 1702 using data collection coordination, which includes the same NFs as discussed previously. The 5GS architecture 1600 allows any NF to request network analytics information from NWDAF containing an analytics logical function (AnLF) 1662a (see e.g., architecture 1704) via the Nnfdaf interface. Analytics exposure to an NWDAF service consumer can take place using, for example, analytics subscribe/notify service operations (see e.g., [TS23288] §§ 6.1.1.1, 7.2), request/response service operations (see e.g., [TS23288] §§ 6.1.2.1, 7.3), via the DCCF 1663 (see e.g., [TS23288] §§ 6.1.4.2, 7.4), via the MFAF 1665 and/or messaging framework 1664 (see e.g., [TS23288] §§ 6.1.4.4, 7.4).

In some examples, the NWDAF 1662 belongs to the same PLMN as the NF that consumes the analytics information (e.g., am NWDAF consumer). The Nnwdaf interface is defined for 5GC NFs, to request subscription to network analytics delivery for a particular context, to cancel subscription to network analytics delivery, and to request a specific report of network analytics for a particular context. In some examples, the 5GS architecture also allows other consumers (e.g., OAM and/or charging enablement function (CEF)) to request network analytics information from NWDAF 1662. The contents of the analytics exposure includes the input parameters listed in [TS23288] §§ 6.1.3, 7 and/or as discussed herein. These input parameters are provided by the consumers of the Nnwdaf_AnalyticsSubscription_Subscribe and/or Nnwdaf_AnalyticsInfo_Request service operations described in clause 7 of [TS23288].

The 5GS architecture allows the NWDAF 166 and DCCF 1663 to request historical analytics from an NWDAF 1662 with associated Nnwdaf_DataManagement services (see e.g., [TS23288] §§ 6.1.4.3, 7.4). The 5GS architecture allows the MFAF 1665 and/or messaging framework 1664 to fetch historical analytics from an NWDAF 1662 with associated Nnwdaf_DataManagement service (see e.g., [TS23288] §§ 6.1.4.5, 7.4).

Additionally or alternatively, the 5GS architecture allows any NF to obtain analytics from an NWDAF 1662 using the DCCF 1663 with associated Ndccf services (see e.g., [TS23288] §§ 6.1.4.2, 8.2). As shown by FIG. 17, the Ndccf interface is defined for any NF to support subscription request(s) to network analytics (e.g., NWDAF 1662), to cancel subscription for network analytics, and to request specific report(s) of network analytics. If the analytics is not already being collected, the DCCF 1663 requests the analytics from the NWDAF 1662 using Nnwdaf services. The DCCF 1663 may collect the analytics and deliver it to the NF, or the DCCF 1663 may rely on the messaging framework 1664 to collect analytics and deliver it to the NF.

FIG. 17 also depicts an example data storage architecture 1703 for analytics and collected data, which includes an NF, DCCF 1663, MFAF 1665 in the messaging framework 1664, and an Analytics Data Repository Function (ADRF) 1666. The 5GS architecture allows the ADRF 1666 to store and retrieve the collected data and analytics in one or more databases 1667, which may implement any suitable database management system.

The ADRF 1666 exposes Nadrf services (e.g., via an Nadrf interface) for storage and retrieval of data by other NFs (e.g., NWDAF 1662, and/or any other NF, such as any of those discussed herein) which access the data using Nadrf services. For example, data may be stored in the ADRF 1666 by a consumer the sending ADRF 1666 an Nadrf_DataManagement_StorageRequest containing the data or analytics to be stored. In some examples, the Nadrf_DataManagement_StorageRequest sent by a service consumer can include the data to be stored, data collection timestamp(s), analytics with timestamp, service operation, analytics specification or data specification, storage handling information, DataSetTag, and/or other suitable information. ADRF response provides and/or sends an The Nadrf_DataManagement_StorageRequest Response message to the consumer with a result indication. As examples, the response can include an indication that data and/or analytics is stored, whether the ADRF 1666 determined that data or analytics is already stored, the storage approach, and/or other suitable information such as any of those discussed herein. A consumer sending an Nadrf_DataManagement_RetrievalRequest request to the ADRF 1666 to retrieve data or analytics for a storage transaction identifier or a fetch instructions received from the ADRF 1666 in an Nadrf_DataManagement RetrievalNotify. The ADRF 1666 determines the availability of the data or analytics in its repository and sends either the data or analytics in a response to the consumer.

Additionally or alternatively, collected data and analytics may be stored in the ADRF 1666 using the procedure(s) specified in [TS23288] §§ 6.2B.2 and 6.2B.3, and collected data and analytics may be deleted from the ADRF 1666 using the procedure(s) specified in [TS23288] § 6.2B.4.

ML models may be stored in the ADRF 1666 by a consumer sending the ADRF 1666 an Nadrf_MLModelManagement_StorageRequest containing the ML model or ML model address to be stored. The ADRF response provides a result indication. An ML model may be deleted from the ADRF 1666 by a consumer sending an Nadrf_MLModelManagement_Delete request. The ADRF response provides a result indication. Additionally or alternatively, ML model(s) may be stored in the ADRF 1666 using the procedure(s) specified in [TS23288] § 6.2B.5, ML model(s) may be deleted from the ADRF 1666 using the procedure(s) specified in [TS23288] § 6.2B.6, and ML model(s) may be retrieved from the ADRF 1666 using the procedure(s) specified in [TS23288] § 6.2B.7.

Based on the NF request or configuration on the DCCF 1663, the DCCF 1663 may determine or identify the ADRF 1666 and interact directly or indirectly with the ADRF 1666 to request or store data. Direct interactions involve the DCCF 1663 requesting to store data in the ADRF 1666 via an Nadrf service, or via an Ndccf_DataManagement_Notify (e.g., when ADRF 1666 requested data collection notification via DCCF 1663). In addition, the DCCF 1663 retrieves data from the ADRF 1666 via an Nadrf service. Indirect interactions involve the DCCF 1663 requesting that the messaging framework 1664 to store data in the ADRF 1666 via an Nadrf service or via an Nmfaf_3daDataManagement_Configure service. The messaging framework 1664 may contain one or more adaptors that translate between 3GPP defined protocols (e.g., MFAF 1665 and/or some other adaptors). An NF service consumer may specify in requests to the DCCF 1663 that data provided by a data source needs to be stored in the ADRF 1666. The ADRF 1666 stores data received in an Nadrf_DataManagement_StorageRequest sent directly from an NF, or data received in an Ndccf_DataManagement_Notify, Nmfaf_3caDataManagement Notify, or Nnwdaf_DataManagement_Notify from the DCCF 1663, MFAF 1665, and/or from the NWDAF 1662. The ADRF 1666 checks if the data consumer is authorized to access ADRF services and provides the requested data using the procedures specified in [TS23501] § 7.1.4.

Data collection coordination is supported by a DCCF 1663 or an NWDAF 1662. The data consumer may use an NRF 1654 to perform NF discovery and selection to find a DCCF 1663 that can coordinate data collection (DCCF discovery principles are defined in [TS23501] § 6.3.19). In some examples, data consumers send requests for data to the DCCF 1663 rather than directly to the NF data source. Whether the data consumers directly contacts the NF data source or goes via the DCCF 1663 is based on configuration of the data consumers and/or can be based on use case and/or implementation. For the data consumer and each notification endpoint in a data request, the data consumer may specify formatting and processing instructions that determine how the data is to be provided. Upon receiving a request from a data consumer, the selected DCCF 1663 determines the NF instance that can be a data source if the data source is not indicated in the data consumer's request. The DCCF 1663 may also select an ADRF 1666 if the data is to be stored in an ADRF 1666 and an ADRF 1666 endpoint is not indicated in the data consumer's request. To retrieve data for a specific UE, the NRF 1654, UDM or BSF can provide the DCCF 1663 with the identity of the data source using the services indicated in table 5A.2-1 in [TS23888]. In some implementations, UPIC 610, RTIC 620, one or more RANs 1604, and/or any other NF(s) discussed herein can be a data source and/or a data consumer.

The DCCF 1663 keeps track of the data actively being collected from the data sources it is coordinating. It may do so by maintaining a record of the active prior requests it sends to each data source. If an NWDAF 1662 subscribes for data directly with a data source, or a data source has stored data in an ADRF 1666, the NWDAF 1662 or ADRF 1666 may register the data collection profile with the DCCF 1663. The data collection profile may include one or more of the following parameters: “Service Operation” identifies the service used to collect the data or analytics from a data source (e.g., Namf_EventExposure_Subscribe or Nnwdaf_AnalyticsSubscription_Subscribe); “Analytics/Data Specification” is the “Service Operation” specific parameters that identify the collected data (e.g., analytics ID(s), event ID(s), target of analytics reporting, target of event reporting, analytics filter, event filter, and/or the like); NWDAF ID or ADRF ID specifies the ADRF 1666 or NWDAF 1662, which registers data collection profile; and/or the like. The DCCF 1663 may then determine certain historical data may be available in the NWDAF 1662 or ADRF 1666 and coordinate collection of data from the NWDAF 1662 or ADRF 1666 based on the data collection profile.

When the DCCF 1663 receives a request for data, it determines the status of data collection from the data source. If parameters in a request for data from a data consumer match those in a prior request or in a data collection profile registration, the DCCF 1663 may determine that the requested data is already being collected from a data source or that a prior subscription to a data source may be modified to in addition satisfy the requirements of the new data request from a data consumer. This status is used in [TS23888] § 5A.3 to deliver data to the data consumer and notification endpoints.

For persisting event exposure subscriptions for long-lived data collection, the DCCF 1663 may subscribe to the UDM 1658 to receive event notifications even if a data source that serves a UE 1602 changes. The DCCF 1663 may subscribe to the NRF 1654 to receive event notifications if a data source changes (e.g., because of a NF life-cycle event).

In some examples, a DCCF 1663 can support multiple data sources, data consumers, and/or message frameworks 1664. Additionally or alternatively, each data source NF or set of data source NFs may be associated with only one DCCF 1663 instance or DCCF set to avoid duplicate data collection. The number of data sources, data consumers, and/or message frameworks 1664 associated with a DCCF 1663 can be based on use case and/or may be implementation-specific, and in some examples, can dynamically change based on various conditions, parameters, and/or criteria.

A DCCF 1663 may use the same mechanisms described in [TS23888] § 6.2.2.1 to determine an AMF 1644 and/or SMF 1646 to retrieve data related to “any UE”. If a data consumer requests to collect data for any UE in an AoI, the data consumer shall first determine all DCCFs 1663 covering the AoI and then contact these DCCFs 1663 to request for data collection.

FIG. 17 depicts an example trained ML model provisioning architecture 1704. The NWDAF 1662 may contain an analytics logical function (AnLF) 1662a and/or a model training logical function (MTLF) 1662b. The NWDAF 1662 can contain only an MTLF 1662b, only an AnLF 1662a, or both logical functions 1662a, 1662b. The 5GS architecture allows an NWDAF containing an AnLF 1662a (also referred to herein as “NWDAF-ANLF 1662a”) to use trained ML model provisioning services from the same or different NWDAF containing an MTLF 1662b (also referred to herein as “NWDAF-MTLF 1662b”). The Nnwdaf interface is used by the NWDAF-AnLF 1662a to request and subscribe to trained ML model provisioning services provided by the NWDAF-MTLF 1662b. The NWDAF 1662 provides an Nnwdaf_MLModelProvision service enables an NF service consumer to receive a notification when an ML model matching the subscription parameters becomes available in the NWDAF-MTLF 1662b (see e.g., clause 7.5 of [TS23288]). The NWDAF 1662 provides an Nnwdaf_MLModelInfo service that enables an NF service consumer to request and get ML Model information from the NWDAF-MTLF 1662b (see e.g., clause 7.6 of [TS23288].

The AnLF 1662a is a logical function in the NWDAF 1662 that performs and/or generates inferences, derives analytics information (e.g., derives statistics, inferences, and/or predictions based on analytics consumer requests), and/or exposes analytics services (e.g., Nnwdaf_AnalyticsSubscription or Nnwdaf_AnalyticsInfo). Analytics information are either statistical information of past events and/or predictive information (e.g., inferences and/or data based on inferences). For purposes of the present disclosure, the term “inference” refers to the process of using trained AI/ML model(s) to generate statistical inferences, statistical information, predictive information (or predictions), decisions, probabilities, probability distributions, actions, configurations, policies, data analytics, outcomes, optimizations, and/or the like based on new and/or unseen data (e.g., “input inference data”).

The MTLF 1662b is a logical function in the NWDAF 1662 that trains AI/ML models and exposes new training services (e.g., providing trained ML model) as defined in clauses 7.5 and 7.6 of [TS23288]. In some examples, the AnLF 1662a can operate AI/ML model(s) trained by the MTLF 1662b and/or the MTLF 1662b can train AI/ML model(s) to be deployed to one or more NFs, AFs 1660, and/or non-3GPP entities/elements.

The consumers of the ML model discovery, provisioning, deployment, (re) training, and/or other services (e.g., NWDAF-AnLF 1662a, SMF 1646, UPF 1648, UPIC 610, RTIC 620, and/or the like) as described herein and/or in [TS23288] §§ 7.5 and 7.6 may provide any combination of the following input parameters in any of the messages mentioned herein (e.g., any of the messages discussed previously w.r.t FIGS. 2-5, 7-11, and 13-15): information of the analytics for which the requested ML model is to be used; indication of supporting multiple ML models; accuracy level(s) of interest; number of ML model(s) (e.g., indicating the maximum number of ML models that the NWDAF-MTLF 1662b could provide to the NWDAF-AnLF 1662a and/or to other NFs, entities, or elements, and in some examples, multiple ML models filter information are composed by accuracy level(s) of interest and number of ML model(s)); time when model is needed: indicates the latest time when the consumer expects to receive the ML model(s); ML model monitoring information, and/or any other information/data, such as any of those mentioned herein.

Examples of the information of the analytics for which the requested ML model is to be used include: a list of analytics ID(s): identifies the analytics for which the ML model is used, NF consumer information (e.g., vendor/developer ID of an NWDAF-AnLF 1662a, ML model, SE, and/or the like), use case context (e.g., indicates the context of use of the analytics and/or desired ML tasks/domains (e.g., used by the NWDAF-MTLF 1662b) to select the most relevant ML model, such as when several (candidate) ML models are available for requested analytics ID(s)), ML model interoperability information (e.g., vendor-specific information that conveys, for example, requested model file format, model execution environment, and/or the like; the encoding, format, and value of ML model interoperability information is vendor specific information, and can be agreed between vendors if necessary for sharing purposes), ML model filter information (e.g., enables the NWDAF-MTLF 1662b to select which ML model for the analytics is requested, such as S-NSSAI, AoI, and/or the like; and parameter types in the ML model filter information are the same or similar as parameter types in the analytics filter information which are defined in procedures); target of ML model reporting (e.g., indicates the object(s) for which ML model is requested, for example, specific UEs 1602, a group of UE(s) 1602, any and/or all UEs 1602, a desired NF, a desired AF 1660, and/or the like); requested representative ratio (e.g., a minimum percentage of UEs 1602 in the group and/or NFs whose data is a non-empty set and can be used in the model training when the target of ML model reporting is a group of UEs 1602 and/or NFs); ML model reporting information parameters (e.g., as per Event Reporting Information Parameter defined in Table 4.15.1-1 of [TS23502]; in some examples, the ML model reporting information parameters are included only for Nnwdaf_MLModelProvision_Subscribe); ML Model Target Period (e.g., indicates time interval [start, end] for which ML model for the analytics is requested; in some examples, the time interval is expressed with actual start time and actual end time (e.g., via UTC time)); inference input data information (e.g., contains information about various settings that are expected to be used by AnLF during inferences such as the “input data” that are expected be used (or a subset of the possible input data specified for a certain analytics type), each of them optionally accompanied by metrics that show the granularity with which this data will be used (e.g., a sampling ratio, the maximum number of input values, and/or a maximum time interval between the samples of this input data), and the data sources that are expected to be used as a list of NF instance (or NF set) identifiers); and/or a notification target address (e.g., +notification correlation ID as defined in [TS23502] § 4.15.1 allowing to correlate notifications received from the NWDAF-MTLF 1662b with this subscription).

Examples of the ML model monitoring information include: ML model metric(s) (e.g., ML model accuracy and/or other ML model performance metrics, such as any of those mentioned herein, in ‘155, ‘122, ‘609, and/or [MLAS]); ML model monitoring reporting mode (e.g., accuracy reporting interval or pre-determined status; depending on the reporting mode, the NWDAF-MTLF 1662b reports the model accuracy to NWDAF-AnLF 1662a either periodically or when the ML model accuracy is crossing an ML Model Accuracy threshold, for example, the accuracy either becomes higher or lower than the ML Model Accuracy threshold); ML model accuracy threshold (e.g., indicating the accuracy threshold of the ML model requested by the consumer (as a kind of pre-determined status); it also can be used as an indication that the MTLF is triggered to execute the accuracy monitoring operations for the ML Model provisioned to AnLF 1662a); DataSetTag and/or ADRF ID if available (e.g., indicates the inference data (including input data, prediction and the ground truth data at the time which the prediction refers to) stored in ADRF which can be used by MTLF to retrain or reprovision of the ML model); and/or ML model identifier (ID) (e.g., indicates the ML model that the data corresponding to the DataSetTag is related to (in the case of subscription modification) and/or a reference associated with the ML model).

It should be noted that any of the aforementioned input parameters can be used as output parameters for other entities/elements and/or for other purposes. For example, some or all of the aforementioned input parameters can be provided to a ML model service provider (e.g., NWDAF-MLTF 1662b and/or the like) by a NF service consumer, and the ML model service provider can provide some or all of the obtained input parameters as output (or input) parameters to one or more other NFs.

The NWDAF-MTLF 1662b (or some other entity/element, such as any of those discussed herein) provides to the consumer of the ML model discovery, provisioning, deployment, (re) training, and/or other service operations (e.g., NWDAF-AnLF 1662a, SMF 1646, UPF 1648, UPIC 610, RTIC 620, and/or the like) as described herein and/or in [TS23288] §§ 7.5 and 7.6, any combination of the following output parameters in any of the messages mentioned herein (e.g., any of the messages discussed previously w.r.t FIGS. 2-5, 7-11, and 13-15): notification correlation information (e.g., only for Nnwdaf_MLModelProvision_Notify); ML model performance information (e.g., indicates the performance of the ML model if ML model performance threshold(s) is/are requested, which includes the value(s) of each performance metric value and the ML model metric (e.g., ML model accuracy and/or other ML model performance metrics, such as any of those mentioned herein, in ‘155, ‘122, ‘609, and/or [MLAS]); for example, ML model accuracy information indicates the accuracy of the ML model if ML Model accuracy threshold is requested, which includes the accuracy value of the ML model and the ML model accuracy metric(s)); and for each analytics ID requested by the service consumer, a set of pair(s) of unique ML model ID and one or more of the following information: ML Model Information, which includes: the ML model file address (e.g., URL, FQDN, and/or some other address, reference, or identifier); and/or ADRF (Set) ID (in some examples, when ADRF (Set) ID is provisioned, a Storage Transaction ID may also be provisioned), ML model degradation indicator (e.g., indicates whether the provided ML model is degraded, validity period (e.g., indicates time period when the provided ML model information applies), spatial validity (e.g., indicates Area where the provided ML Model Information applies), ML model representative ratio (e.g., indicates the percentage of UEs 1602 and/or NFs in the group whose data is used in the ML model training when the target of ML model reporting is a group of UEs 1602 and/or NFs), and/or training input data information (e.g., contains information about various settings that have been used by the MTLF 1662b during training, such as: the “input data” that have been used (or a subset of the possible input data specified for a certain analytics type), each of them optionally accompanied by metrics that show the data characteristics and granularity with which this data has been used (e.g., a sampling ratio, the maximum number of input values and/or a maximum time interval between the samples of this input data, data range including maximum and minimum values, mean and standard deviation and data distribution when applicable) and the time, for example, timestamp and duration, when this data was obtained, and the data sources related to the “input data” that were used for ML model training, which have been identified by a list of NF instance (or NF set) identifiers). In some examples, the spatial validity and validity period are determined by MTLF internal logic and it is a subset of AoI if provided in ML Model Filter Information and of ML Model Target Period, respectively. In some examples, data source information enables ML model selection when different models are available for an Analytics ID, or it enables a consumer to avoid selecting a ML model that used data from a specific data source at a particular time or used data characterized by specific data characteristics.

It should be noted that any of the aforementioned output parameters can be used as input parameters for other entities/elements and/or for other purposes. For example, some or all of the aforementioned output parameters can be provided to an NF service consumer, and the NF service consumer can provide some or all of the obtained output parameters as input parameters to one or more other NFs.

Since multiple NWDAF 1662 instances may be deployed in a network, an NF service consumer can utilize the NRF 1654 to discover NWDAF 1662 instance(s) unless NWDAF information is available by other means (e.g., locally configured on NF service consumers). NF service consumers may make an additional query to the UDM 1658, when supported. An NWDAF selection function in an NF service consumer selects an NWDAF 1662 instance based on the available NWDAF 1662 instances.

In order to support NFs to discover and select an NWDAF 1662 instance containing MTLF 1662b, an NWDAF 1662 instance containing AnLF 1662a, or both, that is/are able to provide the required service(s) (e.g., analytics exposure and/or ML model provisioning) for the required type of analytics, each NWDAF 1662 instance may provide a list of supported analytics ID(s) (e.g., possibly per supported service) when registering to the NRF 1654, in addition to other NRF 1654 registration elements of the NF profile. NFs requiring the discovery of an NWDAF 1662 instance that provides support for some specific service(s) for a specific type of analytics may query the NRF 1654 for NWDAFs 1662 supporting the required service(s) and the required analytics ID(s). The consumers, (e.g., NFs, AFs 1660, and/or OAM entities) decide how to use the data analytics provided by NWDAF 1662. The interactions between NF(s) and the NWDAF 1662 take place within a PLMN.

The NRF 1654 may return one or more candidate NWDAF 1662 instance(s) and each candidate NWDAF 1662 instance (based on its registered profile) supports the analytics ID with a time that is less than or equal to a supported analytics delay. The following factors may be considered by an NF service consumer for NWDAF 1662 selection: S-NSSAI(s); analytics ID(s); supported service(s), possibly with their associated analytics IDs; NWDAF serving area information (e.g., a list of TAIs for which the NWDAF 1662 can provide analytics, trained ML models and/or data, and/or other NWDAF services); NF type of the data source when DCCF 1663 is hosted by an NWDAF 1662; NF set ID of the data source; supported analytics delay of the requested analytics ID(s) (see clause 6.2.6.2 of [TS23288]); and/or for multiple deployed NWDAF 1662 instances, NWDAF capabilities (e.g., analytics aggregation capability, analytics metadata provisioning capability, ML model training capabilities, ML model deployment capabilities, and/or the like) When selecting an NWDAF 1662 for ML model provisioning, the following additional factors may be considered by the NWDAF 1662: the ML model filter information parameters, such as S-NSSAI(s) and area(s) of interest (AoI(s)) (see e.g., clause 5.2 of [TS23288]) for the trained ML model(s) per analytics ID(s) and ML model interoperability indicator per analytics ID, if available. When selecting an NWDAF 1662 that supports federated learning (FL), the following additional factors may be considered by the NWDAF 1662: time period of interest (e.g., time interval [start . . . end], during which the FL will be performed); when selecting FL client: FL capability type as FL client per Analytics ID and/or data available by the FL client; and when selecting FL server: FL capability type as FL server per analytics ID and/or the ML model filter information parameters S-NSSAI(s) and AoI(s) (see e.g., [TS23288] § 5.2) for the trained ML model(s) per analytics ID(s), if available.

FIG. 18 illustrates an example cellular network architecture 1800. The network 1800 may operate in a matter consistent with 3GPP technical specifications or technical reports for 6G systems. In some examples, the network 1800 may operate concurrently with network 1600. For example, in some examples, the network 1800 may share one or more frequency or bandwidth resources with network 1600. As one specific example, a UE (e.g., UE 1802) may be configured to operate in both network 1800 and network 1600. Such configuration may be based on a UE including circuitry configured for communication with frequency and bandwidth resources of both networks 1600 and 1800. In general, several elements of network 1800 may share one or more characteristics with elements of network 1600. For the sake of brevity and clarity, such elements may not be repeated in the description of network 1800.

The network 1800 may include a UE 1802, which may include any mobile or non-mobile computing device designed to communicate with a RAN 1808 via an over-the-air connection. The UE 1602 may be similar to, for example, UE 1602. The UE 1802 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 18, in some examples the network 1800 may include a set of UEs 1802 coupled directly with one another via a sidelink interface. The UEs 1802 may be M2M/D2D devices that communicate using physical sidelink channels such as, but not limited to, PSBCH, PSDCH, PSSCH, PSCCH, PSFCH, etc. Similarly, although not specifically shown in FIG. 18, the UE 1802 may be communicatively coupled with an AP such as AP 1606 as described w.r.t FIG. 16. Additionally, although not specifically shown in FIG. 16, in some examples the RAN 1808 may include one or more NANs such as NANs 1614 as described w.r.t FIG. 16. The RAN 1808 and/or the AN of the RAN 1808 may be referred to as a base station (BS), a RAN node, or using some other term or name.

The UE 1802 and the RAN 1808 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 1808 may allow for communication between the UE 1802 and a 6G CN 1810. Specifically, the RAN 1808 may facilitate the transmission and reception of data between the UE 1802 and the 6G CN 1810. The 6G CN 1810 may include various functions such as NSSF 1650, NEF 1652, NRF 1654, PCF 1656, UDM 1658, AF 1660, SMF 1646, and AUSF 1642. The 6G CN 1810 may additional include UPF 1648 and DN 1636 as shown in FIG. 18.

Additionally, the RAN 1808 may include various additional functions that are in addition to, or alternative to, functions of a legacy cellular network such as a 4G or 5G network, such as an evolved service communication proxy control plane (eCSP-C) 1812, service registration function (SRF) 1814, service orchestration exposure function (SOEF) 1818, Service Orchestration and Chaining Function (SOCF) 1820, Data Control Function (Data CF) 1822, Compute Control Function (Comp CF) 1824, service infrastructure control function (SICF) 1826, Communication Control Function (Comm CF) 1828,Data Service Function (Data SF) 1832, evolved service communication proxy user plane (eSCP-U) 1834, Compute Service Function (Comp SF) 1836, and Communication Service Function (Comm SF) 1838.

The Comp CF 1824 and the Comp SF 1836 may be parts or functions of the Computing Service Plane. Comp CF 1824 may be a control plane function that provides functionalities such as management of the Comp SF 1836, computing task context generation and management (e.g., create, read, modify, delete), interaction with the underlaying computing infrastructure for computing resource management, etc., Comp SF 1836 may be a user plane function that serves as the gateway to interface computing service users (such as UE 1802) and computing nodes behind a Comp SF instance. Some functionalities of the Comp SF 1836 may include: parse computing service data received from users to compute tasks executable by computing nodes; hold service mesh ingress gateway or service API gateway; service and charging policies enforcement; performance monitoring and telemetry collection, etc. In some examples, a Comp SF 1836 instance may serve as the user plane gateway for a cluster of computing nodes. A Comp CF 1824 instance may control one or more Comp SF 1836 instances.

The Comm CF 1828 and and the Comm SF 1838 are parts of the communication service plane. The Comm CF 1828 may be the control plane function for managing the Comm SF 1838, communication sessions creation/configuration/releasing, and managing communication session context. The Comm SF 1838 may be a user plane function for data transport. Comm CF 1828 and Comm SF 1838 may be considered as upgrades of SMF 1646 and UPF 1648, which were described w.r.t 5GS 1600. The upgrades provided by the Comm CF 1828 and the Comm SF 1838 may enable service-aware transport. For legacy (e.g., 4G or 5G) data transport, SMF 1646 and UPF 1648 may still be used.

The Data CF 1822 and the Data SF 1832 are parts of the data service plane. Data CF 1822 may be a control plane function and provides functionalities such as Data SF 1832 management,

Data service creation/configuration/releasing, Data service context management, etc. Data SF 1832 may be a user plane function and serve as the gateway between data service users (such as UE 1802 and the various functions of the 6G CN 1810) and data service endpoints behind the gateway. Specific functionalities may include include: parse data service user data and forward to corresponding data service endpoints, generate charging data, report data service status.

The SOCF 1820 discovers, orchestrates, and s up communication, computing, data services, and/or other resources/services provided by functions (e.g., NFs) in the network. After receiving service requests from users and/or NFs, the SOCF 1820 interacts with one or more of Comp CF 1824, Comm CF 1828, and Data CF 1822 to identify Comp SF 1836, Comm SF 1838, and Data SF 1832 instances, configure service resources, and generate the service chain, which could contain multiple Comp SF 1836, Comm SF 1838, and/or Data SF 1832 instances and their associated computing endpoints. Workload processing and data movement may then be conducted within the generated service chain. The SOCF 1820 may also responsible for maintaining, updating, and releasing a created service chain.

The SRF 1814 acts as a registry for system services provided in the user plane such as services provided by service endpoints behind Comp SF 1836 and Data SF 1832 gateways and services provided by the UE 1802. The SRF 1814 may be considered a counterpart of NRF 1654, which may act as the registry for network functions.

The evolved service communication proxy (eSCP) and the SICF 1826 provide service communication infrastructure for control plane services and user plane services. The eSCP may be related to the service communication proxy (SCP) of 5G with user plane service communication proxy capabilities being added. The eSCP is expressed in two parts: eCSP-C 1812 and eSCP-U 1834, for control plane service communication proxy and user plane service communication proxy, respectively. The SICF 1826 may control and configure eCSP instances in terms of service traffic routing policies, access rules, load balancing configurations, performance monitoring, and/or the like.

The AMF 1844 is similar to AMF 1644, but with additional functionality. Specifically, the AMF 1844 may include potential functional repartition, such as move the message forwarding functionality from the AMF 1844 to the RAN 1808. The SOEF 1818 is configured to expose service orchestration and chaining services to external users such as applications.

The UE 1802 may include an additional function that is referred to as a computing client service function (comp CSF) 1804. The comp CSF 1804 may have both the control plane functionalities and user plane functionalities, and may interact with corresponding network side functions such as SOCF 1820, Comp CF 1824, Comp SF 1836, Data CF 1822, and/or Data SF 1832 for service discovery, request/response, compute task workload exchange, and/or the like.

The Comp CSF 1804 may also work with network side functions to decide on whether a computing task should be run on the UE 1802, the RAN 1808, and/or an element of the 6G CN 1810.

The UE 1802 and/or the Comp CSF 1804 may include a service mesh proxy 1806. The service mesh proxy 1806 may act as a proxy for service-to-service communication in the user plane. Capabilities of the service mesh proxy 1806 may include one or more of addressing, security, load balancing, and/or the like.

FIG. 19 illustrates a wireless network 1900, which includes a UE 1902 in wireless communication with a NAN 1904. The UE 1902 may be the same or similar to, and substantially interchangeable with any of the of the UEs discussed herein such as, for example, UE 1602, hardware resources 2000, and/or the like. The NAN 1904 may be the same or similar to, and substantially interchangeable with any of the NANs discussed herein such as, for example, AP 1606, RAN 1604, NANs 1614, hardware resources 2000, and/or the like.

The UE 1902 can communicatively couple with the NAN 1904 via connection 1906. The connection 1906 is an air interface to enable communicative coupling, and can be consistent with cellular communications protocols (e.g., LTE, 5G/NR, mmWave or sub-6 GHZ frequencies, and/or any other access network protocol). The connection 1906 may correspond to the Uu interface described with respect to (w.r.t) FIG. 16.

The UE 1902 includes a host platform 1908 coupled with a modem platform 1910. The host platform 1908 includes application processing circuitry 1912, which may be coupled with protocol processing circuitry 1914 of the modem platform 1910. The application processing circuitry 1912 may run various applications for the UE 1902 that source/sink application data. The application processing circuitry 1912 may further implement one or more layer operations to transmit/receive application data to/from a data network. These layer operations includes transport (e.g., user datagram protocol (UDP), QUIC (Quick UDP Internet Connections), transmission control protocol (TCP), GPRS Tunneling (GTP), and/or some other transport layer protocol) operations and network/Internet (e.g., internet protocol (IP), IPSec, routing information protocol (RIP), external gateway protocol (EGP), internet control message protocol (ICMP), internet group management protocol (IGMP), and/or some other network and/or Internet layer protocol) operations. The protocol processing circuitry 1914 may perform one or more protocol layer operations to facilitate transmission or reception of data over the connection 1906. The protocol layer operations implemented by the protocol processing circuitry 1914 includes, for example, operations for some or all of the following layers: physical layer (PHY) (see e.g., 3GPP TS 38.201), medium access control (MAC) (see e.g., 3GPP TS 38.321), radio link control layer (RLC) (see e.g., 3GPP TS 38.322), packet data convergence protocol (PDCP) (see e.g., 3GPP TS 38.323), Service Data Adaptation Protocol (SDAP) (see e.g., 3GPP TS 37.324), radio resource control (RRC) (see e.g., 3GPP TS 38.331 (“[TS38331]”), and non-access stratum (NAS) (see e.g., 3GPP TS 24.301 and/or 3GPP TS 24.501).

The modem platform 1910 may further include digital baseband circuitry 1916 that may implement one or more layer operations that are “below” layer operations performed by the protocol processing circuitry 1914 in a network protocol stack. These operations includes, for example, PHY operations including one or more of HARQ functions, scrambling/descrambling, encoding/decoding, layer mapping/de-mapping, modulation symbol mapping, received symbol/bit metric determination, multi-antenna port precoding/decoding, which includes one or more of space-time, space-frequency or spatial coding, reference signal generation/detection, preamble sequence generation and/or decoding, synchronization sequence generation/detection, control channel signal blind decoding, and/or other related functions, including any of those discussed herein and/or in 3GPP TS 36.201, 3GPP TS 38.201, [TS38211], [TS38212], [TS38213], [TS38214], and/or any other standards/specifications, including any of those mentioned herein. In some examples, the protocol processing circuitry 1914 includes one or more instances of control circuitry (not shown) to provide control functions for the transmit/receive components.

The modem platform 1910 may further include transmit circuitry 1918, receive circuitry 1920, RF circuitry 1922, and RF front end (RFFE) 1924, which includes or connect to one or more antenna panels 1926. Briefly, the transmit circuitry 1918 includes a digital-to-analog converter, mixer, intermediate frequency (IF) components, and/or the like; the receive circuitry 1920 includes an analog-to-digital converter, mixer, IF components, and/or the like; the RF circuitry 1922 includes a low-noise amplifier, a power amplifier, power tracking components, and/or the like; RFFE 1924 includes filters (e.g., surface/bulk acoustic wave filters), switches, antenna tuners, beamforming components (e.g., phase-array antenna components), and/or the like The selection and arrangement of the components of the transmit circuitry 1918, receive circuitry 1920, RF circuitry 1922, RFFE 1924, and antenna panels 1926 (referred generically as “transmit/receive components” or “Tx/Rx components”) may be specific to details of a specific implementation such as, for example, whether communication is TDM or FDM, in mmWave or sub-6 gHz frequencies, and/or the like. In some examples, the transmit/receive components may be arranged in multiple parallel Tx/Rx chains, may be disposed in the same or different chips/modules, and/or the like.

A UE reception may be established by and via the antenna panels 1926, RFFE 1924, RF circuitry 1922, receive circuitry 1920, digital baseband circuitry 1916, and protocol processing circuitry 1914. In some examples, the antenna panels 1926 may receive a transmission from the NAN 1904 by receive-beamforming signals received by a set of antennas/antenna elements of the one or more antenna panels 1926. A UE transmission may be established by and via the protocol processing circuitry 1914, digital baseband circuitry 1916, transmit circuitry 1918, RF circuitry 1922, RFFE 1924, and antenna panels 1926. In some examples, the transmit components of the UE 1904 may apply a spatial filter to the data to be transmitted to form a transmit beam emitted by the antenna elements of the antenna panels 1926.

Similar to the UE 1902, the NAN 1904 includes a host platform 1928 coupled with a modem platform 1930. The host platform 1928 includes application processing circuitry 1932 coupled with protocol processing circuitry 1934 of the modem platform 1930. The modem platform may further include digital baseband circuitry 1936, transmit circuitry 1938, receive circuitry 1940, RF circuitry 1942, RFFE circuitry 1944, and antenna panels 1946. The components of the NAN 1904 may be similar to and substantially interchangeable with like-named components of the UE 1902. In addition to performing data transmission/reception as described above, the components of the NAN 1904 may perform various logical functions that include, for example, RNC functions such as radio bearer management, UL and DL dynamic radio resource management, and data packet scheduling. Examples of the antenna elements of the antenna panels 1926 and/or the antenna elements of the antenna panels 1946 include planar inverted-F antennas (PIFAs), monopole antennas, dipole antennas, loop antennas, patch antennas, Yagi antennas, parabolic dish antennas, omni-directional antennas, and/or the like.

FIG. 20 illustrates components capable of reading instructions from a machine-readable or computer-readable medium (e.g., a non-transitory machine-readable storage medium) and perform any one or more of the methodologies discussed herein. Specifically, FIG. 20 shows hardware resources 2000 including one or more processors (or processor cores) 2010, one or more memory/storage devices 2020, and one or more communication resources 2030, each of which may be communicatively coupled via a bus/interconnect 2006 or other interface circuitry. For examples where node virtualization (e.g., NFV) is utilized, a hypervisor 2002 may be executed to provide an execution environment for one or more network slices/sub-slices to utilize the hardware resources 2000. In some examples, the hardware resources 2000 may be implemented in or by an individual compute node, which may be housed in an enclosure of various form factors. In other examples, the hardware resources 2000 may be implemented by multiple compute nodes that may be deployed in one or more data centers and/or distributed across one or more geographic regions.

The processors 2010 may include processors (or cores) 2010-1 to 2010-p (where p is a number). Individual processors 2010-1 to 2010-p may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radio-frequency integrated circuit (RFIC), a microprocessor or controller, a multi-core processor, a multithreaded processor, an ultra-low voltage processor, an embedded processor, an xPU, a data processing unit (DPU), an Infrastructure Processing Unit (IPU), a network processing unit (NPU), another processor (including any of those discussed herein), and/or any suitable combination thereof. Each processor (or core) 2010-1 to 2010-p may be the same as, or different from, each other processor (or core) 2010-1 to 2010-p.

The memory/storage devices 2020 may include main memory, disk storage, or any suitable combination thereof. The memory/storage devices 2020 may include, but are not limited to, any type of volatile, non-volatile, semi-volatile memory, and/or any combination thereof. As examples, the memory/storage devices 2020 can be or include random access memory (RAM), static RAM (SRAM), dynamic RAM (DRAM), synchronous DRAM (SDRAM), magnetoresistive RAM (MRAM), conductive bridge Random Access Memory (CB-RAM), spin transfer torque (STT)-MRAM, phase change RAM (PRAM), core memory, dual inline memory modules (DIMMs), microDIMMs, MiniDIMMs, block addressable memory device(s) (e.g., those based on NAND or NOR technologies), read-only memory (ROM), programmable ROM (PROM), erasable PROM (EPROM), electrically EPROM (EEPROM), flash memory, non-volatile RAM (NVRAM), solid-state storage, magnetic disk storage mediums, optical storage mediums, memory devices that use chalcogenide glass, multi-threshold level NAND flash memory, NOR flash memory, single or multi-level Phase Change Memory (PCM) and/or phase change memory with a switch (PCMS), NVM devices that use chalcogenide phase change material (e.g., chalcogenide glass), a resistive memory, nanowire memory, ferroelectric transistor random access memory (FeTRAM), anti-ferroelectric memory, magnetoresistive random access memory (MRAM) memory that incorporates memristor technology, phase change RAM (PRAM), resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a Domain Wall (DW) and Spin Orbit Transfer (SOT) based device, a thyristor based memory device, and/or a combination of any of the aforementioned memory devices, and/or other memory.

The communication resources 2030 may include interconnection or network interface controllers, components, or other suitable devices to communicate with one or more peripheral devices 2004 or one or more databases 2006 or other network elements via a network 2008. For example, the communication resources 2030 may include wired communication components (e.g., for coupling via USB, Ethernet, and/or the like), cellular communication components, NFC components, Bluetooth® components, WiFi® components, and other communication components.

Instructions 2050 may comprise software, program, apps, applets, and/or other executable code (e.g., the SEs discussed herein) for causing at least any of the processors 2010 to perform any one or more of the methodologies discussed herein. The instructions 2050 may reside, completely or partially, within at least one of the processors 2010 (e.g., within the processor's 2010 cache memory), the memory/storage devices 2020, or any suitable combination thereof. Furthermore, any portion of the instructions 2050 may be transferred to the hardware resources 2000 from any combination of the peripheral devices 2004 or the databases 2040. Accordingly, the memory of processors 2010, the memory/storage devices 2020, the peripheral devices 2004, and the databases 2040 are examples of computer-readable and machine-readable media.

In some examples, the peripheral devices 2004 may represent one or more sensors such as, for example, exteroceptive sensors, proprioceptive sensors, and/or exproprioceptive sensors (e.g., sensors that capture, measure, or correlate internal states and external states). Examples of such sensors include, inter alia, inertia measurement units (IMU) comprising accelerometers, gyroscopes, and/or magnetometers; microelectromechanical systems (MEMS) or nanoelectromechanical systems (NEMS) comprising 3-axis accelerometers, 3-axis gyroscopes, and/or magnetometers; level sensors; flow sensors; temperature sensors/thermistors; pressure sensors; barometric pressure sensors; gravimeters; altimeters; image sensors/cameras; light detection and ranging (LiDAR) sensors; proximity sensors; depth sensors, ambient light sensors; optical light sensors; ultrasonic transceivers; microphones; power, energy, environmental (PEE) sensor(s); gas sensors; and the like.

Additionally or alternatively, the peripheral devices 2004 may represent one or more actuators such as, for example, soft actuators (e.g., actuators that changes its shape in response to a stimuli such as, for example, mechanical, thermal, magnetic, and/or electrical stimuli), hydraulic actuators, pneumatic actuators, mechanical actuators, electromechanical actuators (EMAs), microelectromechanical actuators, electrohydraulic actuators, linear actuators, linear motors, rotary motors, DC motors, stepper motors, servomechanisms, electromechanical switches, electromechanical relays (EMRs), power switches, valve actuators, piezoelectric actuators and/or biomorphs, thermal biomorphs, solid state actuators, solid state relays (SSRs), shape-memory alloy-based actuators, electroactive polymer-based actuators, relay driver integrated circuits (ICs), solenoids, impactive actuators/mechanisms (e.g., jaws, claws, tweezers, clamps, hooks, mechanical fingers, humaniform dexterous robotic hands, and/or other gripper mechanisms that physically grasp by direct impact upon an object), propulsion actuators/mechanisms (e.g., wheels, axles, thrusters, propellers, engines, motors (e.g., those discussed previously), clutches, and the like), projectile actuators/mechanisms (e.g., mechanisms that shoot or propel objects or elements), and/or audible sound generators, visual warning devices, and/or other like electromechanical components.

### 6. Example Implementations

FIG. 21 shows an example process 2100 to be performed by a UPIC 610. The process 2100 includes, at operation 2101, receiving an ML model request from a service consumer (e.g., SMF 1646); and at operation 2102, sending an ML model response to the service consumer based on the ML model request. In one example, the ML model request includes query parameters to be used to search for an ML model, and the ML model response includes the ML model or a reference to where the ML model can be accessed or obtained. In another example, the ML model request is an ML model discovery request that includes an ML model filter indicating aspects of a desired ML model; and the ML model response is an ML model discovery response that includes a set of candidate ML models and/or references to corresponding ones of the set of candidate ML models. In another example, the ML model request is an ML model training request that includes ML model parameters, hyperparameters, and/or training data, or references to where the model parameters, hyperparameters, and/or training data can be obtained; and the ML model response is an ML model training response indicating whether the training request was accepted or not, and/or whether the ML model training was successful or not.

FIG. 22 shows an example process 2200 to be performed by an SMF 1646. The process 2200 includes, at operation 2201, sending a programmability request to a UPF 1648 to program the UPF 1648 with a trained ML model or otherwise deploy the trained ML model at the UPR 1648; and at operation 2202, receiving a programmability response from the UPF 1648 based on the programmability request. In some examples, the programmability request is an N4_programmabilityConfig_request message include model information and/or parameters, and the programmability response is an N4_programmabilityConfig_response message.

FIG. 23 shows an example process 2300 to be performed by a first network element (NE). The process 2300 includes, at operation 2301, sending a request to retrain an ML model to a second NE; and at operation 2302, receiving a response/notification including the retrained ML model or a reference to where the retrained ML model can be accessed or obtained. In one example, the first NE is a UPF 1648 (or an RTIC 620) and the second NE is a UPIC 610, and the UPIC 610 retrains the ML model or interacts with an NWDAF 1662 to retrain the ML model. In this example, the response/notification may be received from the UPIC 610 or the NWDAF 1662. In another example, the first NE is a UPIC 610 and the second NE is an SMF 1646, and the SMF 1646 interacts with a UPF 1648 (or an RTIC 620) to retrain the ML model. In this example, the response/notification may be received from the a UPF 1648 (or RTIC 620) or the SMF 1646.

The example operations of processes 2100, 2200, and 2300 can be arranged in different orders, one or more of the depicted operations may be combined and/or divided/split into multiple operations, depicted operations may be omitted, and/or additional or alternative operations may be included in any of the depicted processes. Additional examples of the presently described methods, devices, systems, and networks discussed herein include the following, non-limiting example implementations.

Each of the following non-limiting examples may stand on its own or may be combined in any permutation or combination with any one or more of the other examples provided below or throughout the present disclosure.

Example 1 includes a method of operating a user plane intelligent controller (UPIC), the method comprising: receiving, from a service consumer, a machine learning (ML) model discovery request, wherein the ML model request includes an ML model filter indicating aspects of a desired ML model; and sending, to the service consumer, an ML model discovery response based on the ML model discovery request.

Example 2 includes the method of example 1 and/or some other example(s) herein, wherein the ML model discovery response indicates whether any available candidate ML models that meet the ML model filter have been discovered or found.

Example 3 includes the method of examples 1-2 and/or some other example(s) herein, wherein the ML model discovery response includes a set of candidate ML models and corresponding model metadata.

Example 4 includes the method of examples 1-2 and/or some other example(s) herein, wherein the ML model discovery response includes: a set of references to storage locations where corresponding ones of a set of candidate ML models can be obtained or accessed; and a set of ML model IDs for the corresponding ones of the set of candidate ML models.

Example 5 includes the method of examples 1~4 and/or some other example(s) herein, wherein the method includes: performing one or more ML model search operations based on the ML model filter.

Example 6 includes the method of example 5 and/or some other example(s) herein, wherein the ML model filter includes one or more of: an ML model identifier (ID), version number, developer or vendor ID, system or platform requirements, model parameters, hyperparameter requirements, inference generation speed, and inference accuracy requirements.

Example 7 includes the method of examples 1-6 and/or some other example(s) herein, wherein the method includes: receiving, from the service consumer, an ML model training request that includes model parameters, hyperparameters, or training data, or references to where the model parameters, the hyperparameters, or the training data can be obtained; and sending, to the service consumer, an ML model training response indicating whether the training request was accepted or not.

Example 8 includes the method of example 7 and/or some other example(s) herein, wherein, when the training is accepted, the method includes: performing an ML model training process based on the ML model training request when the ML training request is accepted; or deploying one or more ML models to a real-time intelligent controller (RTIC) to perform ML model training based on the ML model training request.

Example 9 includes the method of example 7 and/or some other example(s) herein, wherein, when the training is accepted, the method includes: performing an ML model training process based on the ML model training request when the ML training request is accepted; or deploying one or more ML models to an RTIC to perform ML model inference.

Example 10 includes the method of examples 8-9 and/or some other example(s) herein, wherein the method includes: sending an ML training notification to the service consumer, wherein the ML training notification indicates success or failure of the ML model training process, or the ML training notification includes the trained ML model or a reference to where the trained ML model can be obtained.

Example 11 includes the method of examples 8-10, and/or some other example(s) herein, wherein the method includes: receiving a request to retrain the ML model based on an inference output produced by a user plane function (UPF) or the RTIC.

Example 12 includes the method of examples 8-10, and/or some other example(s) herein, wherein the method includes: receiving a request to retrain the ML model based on an output or event produced by a UPF or the inference output by the RTIC.

Example 13 includes the method of examples 1-12 and/or some other example(s) herein, wherein the service consumer is a session management function (SMF).

Example 14 includes the method of examples 1-13 and/or some other example(s) herein, wherein the method includes: receiving an ML model registration request from a model provider; allocating a model ID to an ML model indicated by the ML model registration request; and sending an ML model registration response to the model provider based on the ML model registration request, wherein the ML model registration response includes the allocated model ID.

Example 15 includes the method of example 14 and/or some other example(s) herein, wherein the model registration request includes model training history, input/output descriptions, software (SW) dependencies, hardware (HW) dependencies, training data set(s).

Example 16 includes the method of examples 14-15 and/or some other example(s) herein, wherein the method includes: generating one or more tags corresponding to the model ID, wherein the one or more tags include one or more rulesets.

Example 17 includes the method of example 16 and/or some other example(s) herein, wherein the one or more rulesets include any combination selected from a group including: Packet Detection Rule (PDR), Packet Detection Information (PDI), Packet Flow Description (PFD), Forwarding Action Rule (FAR), QoS Enforcement Rule (QER), Usage Reporting Rule (URR), Buffer Action Rule (BAR), Multi-Access Rule (MAR), Session Reporting Rule (SRR), or Policy and Charging Control (PCC) rule.

Example 18 includes the method of examples 16-17 and/or some other example(s) herein, wherein the one or more tags include one or more of uplink classifier(s), trace requirement(s), port management information container(s), and/or bridge/router information.

Example 19 includes the method of examples 14-18 and/or some other example(s) herein, wherein the method includes: performing one or more operations for deployment of the ML model to a UPF based on its programmability.

Example 20 includes the method of example 19 and/or some other example(s) herein, wherein the method includes: receiving, from an RTIC via an Ni4 interface, a request to retrain the deployed ML model using a new or alternative dataset; and providing the deployed ML model to the RTIC over the Ni4 interface based on the request.

Example 21 includes the method of example 20 and/or some other example(s) herein, wherein the request to retrain the deployed ML model from the RTIC is based on one or more triggers configured at the RTIC.

Example 22 includes the method of examples 20-21 and/or some other example(s) herein, wherein the method includes: sending, to a model training logical function (MTLF), a request to retrain the deployed ML model, wherein the request to retrain the deployed ML model includes the new or alternative dataset or a reference to an analytics logical function (AnLF) where the new or alternative dataset can be obtained; and sending, to the RTIC, a request to deploy the retrained

ML model, wherein the request to deploy the retrained ML model is to cause the RTIC to notify the UPF of the redeployed ML model.

Example 23 includes the method of examples 20-22 and/or some other example(s) herein, wherein the RTIC is a function in or part of the UPF,

Example 24 includes the method of examples 14-23 and/or some other example(s) herein, wherein the model provider is an application function, a Network Exposure Function (NEF), or a network and data analytics function (NWDAF) containing model training logical function (MTLF).

Example Z01 includes one or more computer readable media comprising instructions, wherein execution of the instructions by processor circuitry is to cause the processor circuitry to perform the method of any one of examples 1-24. Example Z02 includes a computer program comprising the instructions of example Z01. Example Z03 includes an Application Programming Interface defining functions, methods, variables, data structures, and/or protocols for the computer program of example Z02. Example Z04 includes an API or specification defining functions, methods, variables, data structures, protocols, and the like, defining or involving use of any of examples 1-24 or portions thereof, or otherwise related to any of examples 1-24 or portions thereof. Example Z05 includes an apparatus comprising circuitry loaded with the instructions of example Z01. Example Z06 includes an apparatus comprising circuitry operable to run the instructions of example Z01. Example Z07 includes an integrated circuit comprising one or more of the processor circuitry of example Z01 and the one or more computer readable media of example Z01. Example Z08 includes a computing system comprising the one or more computer readable media and the processor circuitry of example Z01. Example Z09 includes an apparatus comprising means for executing the instructions of example Z01. Example Z10 includes a signal generated as a result of executing the instructions of example Z01. Example Z11 includes a data unit generated as a result of executing the instructions of example Z01. Example Z12 includes the data unit of example Z10 and/or some other example(s) herein, wherein the data unit is a datagram, network packet, data frame, data segment, a Protocol Data Unit (PDU), a Service Data Unit (SDU), a message, or a database object. Example Z13 includes a signal encoded with the data unit of examples Z11 and/or Z12. Example Z14 includes an electromagnetic signal carrying the instructions of example Z01. Example Z15 includes an apparatus comprising means for performing the method of any one of examples 1-24 and/or some other example(s) herein. Example Z16 includes a compute node executing a service as part of one or more applications instantiated on virtualization infrastructure, the service being related to any of examples 1-24, portions thereof, and/or some other example(s) herein. Example Z17 includes a method of communicating in a wireless network as shown and described herein. Example Z18 includes a system for providing wireless communication as shown and described herein. Example Z19 includes a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### 7. Terminology

For the purposes of the present document, the following terms and definitions are applicable to the examples and embodiments discussed herein. Additionally, the terminology discussed in ‘155, ‘122, ‘609, [TS23501], [TS23502], [TS23503], and/or 3GPP TS 21.905 may also be applicable to the examples and embodiments discussed herein.

As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, epochs, iterations, stages, and/or components, but do not preclude the presence or addition of one or more other features, integers, steps, operation, elements, components, and/or groups thereof. The phrase “A and/or B” means (A), (B), or (A and B). For the purposes of the present disclosure, the phrase “A, B, and/or C” means (A), (B), (C), (A and B), (A and C), (B and C), or (A, B and C). The phrase “X(s)” means one or more X or a set of X. The description may use the phrases “in an embodiment,” “In some embodiments,” “in one implementation,” “In some implementations,” “in some examples”, and the like, each of which may refer to one or more of the same or different embodiments, implementations, and/or examples. Furthermore, the terms “comprising,” “including,” “having,” and the like, as used with respect to the present disclosure, are synonymous.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or ink, and/or the like.

The term “access technology” at least in some examples refers to the technology used for the underlying physical connection to a communication network. The term “radio access technology” or “RAT” at least in some examples refers to the technology used for the underlying physical connection to a radio based communication network. The term “radio technology” at least in some examples refers to technology for wireless transmission and/or reception of electromagnetic radiation for information transfer. The term “RAT type” at least in some examples may identify a transmission technology and/or communication protocol used in an access network. Examples of access technologies are discussed in ‘155, ‘122, and ‘609.

The term “application programming interface” or “API” at least in some examples refers to a set of subroutine definitions, communication protocols, and tools for building software. Additionally or alternatively, the term “application programming interface” or “API” at least in some examples refers to a set of clearly defined methods of communication among various components. In some examples, an API may be defined or otherwise used for a web-based system, operating system, database system, computer hardware, software library, and/or the like.

The term “filter” at least in some examples refers to computer program, subroutine, or other software element capable of processing a stream, data flow, or other collection of data, and producing another stream. In some implementations, multiple filters can be strung together or otherwise connected to form a pipeline. Additionally or alternatively, the term “filter” at least in some examples refers to parameters, conditions, criteria, data, values, information, and/or the like that enables selection of a type of information being requested.

The terms “instantiate,” “instantiation,” and the like at least in some examples refers to the creation of an instance. An “instance” also at least in some examples refers to a concrete occurrence of an object, which may occur, for example, during execution of program code.

The term “machine learning” or “ML” at least in some examples refers to the use of computer systems to optimize a performance criterion using example (training) data and/or past experience. ML involves using algorithms to perform specific task(s) without using explicit instructions to perform the specific task(s), and/or relying on patterns, predictions, and/or inferences. ML uses statistics to build ML model(s) (also referred to as “models”) in order to make predictions or decisions based on sample data (e.g., training data).

The term “machine learning model” or “ML model” at least in some examples refers to an application, program, process, algorithm, and/or function that is capable of making predictions, inferences, or decisions based on an input data set and/or is capable of detecting patterns based on an input data set. In some examples, a “machine learning model” or “ML model” is trained on a training data to detect patterns and/or make predictions, inferences, and/or decisions. In some examples, a “machine learning model” or “ML model” is based on a mathematical and/or statistical model. For purposes of the present disclosure, the terms “ML model”, “AI model”, “AI/ML model”, and the like may be used interchangeably.

The term “machine learning application” or “ML application” at least in some examples refers to an application, program, process, algorithm, and/or function that contains some AI/ML model(s) and application-level descriptions. Additionally or alternatively, the term “machine learning application” or “ML application” at least in some examples refers to a complete and deployable application and/or package that includes at least one ML model and/or other data capable of achieving a certain function and/or performing a set of actions or tasks in an operational environment. For purposes of the present disclosure, the terms “ML application”, “AI application”, “AI/ML application”, and the like may be used interchangeably.

The term “machine learning entity” or “ML entity” at least in some examples refers to an entity that is either an ML model or contains an ML model and ML model-related metadata that can be managed as a single composite entity (in some examples, metadata may include, for example, the applicable runtime context for the ML model). For purposes of the present disclosure, the term “AI/ML entity” or “ML entity” at least in some examples refers to an entity that is either an AI/ML model and/or contains an AI/ML model and that can be managed as a single composite entity. Additionally, the term “ML entity training” at least in some examples refers to ML model training associated with an ML entity. Moreover, the term “AI/ML” may be used interchangeably with the terms “Al” and “ML” throughout the present disclosure.

The term “machine learning decision entity”, “ML decision entity”, or “AI decision entity” at least in some examples refers to an entity that applies a non-AI and/or non-ML based logic for making decisions that can be managed as a single composite entity.

The term “machine learning inference function”, “ML inference function”, or “AI/ML inference function” at least in some examples refers to a (logical) function (or set of functions) that employs an ML model and/or AI decision entity to conduct inference. Additionally or alternatively, the term “AI/ML inference function” or “ML inference function” at least in some examples refers to an inference framework used to run a compiled model in the inference host. In some examples, an “AI/ML inference function” or “ML inference function” may also be referred to an “model inference engine”, “ML inference engine”, or “inference engine”.

The term “machine learning training”, “ML training”, or “MLT” at least in some examples refers to capabilities and associated end-to-end (e2e) processes to enable an ML training function to perform ML entity (or ML model) training (e.g., as defined herein). In some examples, ML training capabilities include interaction with other parties/entities to collect and/or format the data required for ML model training. Additionally or alternatively, “training an ML entity” refers to training one or more ML model(s) associated with an ML entity internally by an MLT function. The term “machine learning model training” or “ML model training” at least in some examples refers to capabilities of an ML training function to take data, run the data through an ML model, derive associated loss, optimization, and/or objective/goal, and adjust the parameterization of the ML model based on the computed loss, optimization, and/or objective/goal. The term “ML initial training” at least in some examples refers to ML entity training that generates an initial version of a trained ML entity. The term “ML re-training” at least in some examples refers to MLT that generates a new version of a trained ML entity using the same type, but different values or distributions, of training data as that used to train the previous version of the ML entity. This new version of the trained ML entity (e.g., the re-trained ML entity) supports the same type of inference as the previous version of the ML entity, e.g., the data type of inference input and data type of inference output remain unchanged between the two versions of the ML entity. The term “machine learning training function”, “ML training function”, or “MLT function” at least in some examples refers to a (logical) function with MLT capabilities.

The term “packet processor” at least in some examples refers to software and/or hardware element(s) that transform a stream of input packets into output packets (or transforms a stream of input data into output data); examples of the transformations include adding, removing, and modifying fields in a packet header, trailer, and/or payload.

The term “reference” at least in some examples refers to data useable to locate other data, which may be implemented a variety of ways such as, for example, a pointer, index, handle, key, file path, identifier, network address, hyperlink, universal resource identifier (URI), universal resource locator (URL), universal resource name (URN), domain name, fully qualified domain name (FQDN), name space, digital object identifier (DOI), content-based address, semantic identifier, and/or the like.

The term “reference point” at least in some examples refers to a conceptual point at the conjunction of two non-overlapping functional groups, elements, or entities.

The term “software agent” at least in some examples refers to a computer program that acts for a user or other program in a relationship of agency.

The term “software engine” at least in some examples refers to a component of a software system, subsystem, component, functional unit, module or other collection of software elements, functions, and the like. In some examples, the term “software engine” can be used interchangeably with the terms “software core engine” or simply “engine”.

The term “software framework” at least in some examples refers to an abstraction in which software, providing generic functionality, can be selectively changed by other application-specific code and/or software element(s). Additionally or alternatively, the term “software framework” at least in some examples refers to a standard, universal, and/or reusable software environment that provides particular functionality as part of a larger software platform to facilitate the development of software applications, products, solutions, and/or services. In some examples, software frameworks include support programs, compilers, code libraries, toolsets, APIs, one or more components, and/or other elements/entities that can be used to develop a system, subsystem, engine, components, applications, and/or other elements/entities.

The term “software component” at least in some examples refers to a software package, web service, web resource, module, application, algorithm, and/or another collection of elements, or combination(s) therefore, that encapsulates a set of related functions (or data).

The terms “configuration”, “policy”, “ruleset”, and/or “operational parameters”, at least in some examples refer to a machine-readable information object that contains instructions, conditions, parameters, and/or criteria that are relevant to a device, system, or other element/entity.

The term “data set” or “dataset” at least in some examples refers to a collection of data; a “data set” or “dataset” may be formed or arranged in any type of data structure. In some examples, one or more characteristics can define or influence the structure and/or properties of a dataset such as the number and types of attributes and/or variables, and various statistical measures (e.g., standard deviation, kurtosis, and/or the like). The term “data structure” at least in some examples refers to a data organization, management, and/or storage format. Additionally or alternatively, the term “data structure” at least in some examples refers to a collection of data values, the relationships among those data values, and/or the functions, operations, tasks, and the like, that can be applied to the data. Examples of data structures include primitives (e.g., Boolean, character, floating-point numbers, fixed-point numbers, integers, reference or pointers, enumerated type, and/or the like), composites (e.g., arrays, records, strings, union, tagged union, and/or the like), abstract data types (e.g., data container, list, tuple, associative array, map, dictionary, set (or dataset), multiset or bag, stack, queue, graph (e.g., tree, heap, and the like), and/or the like), routing table, symbol table, quad-edge, blockchain, purely-functional data structures (e.g., stack, queue, (multi) set, random access list, hash consing, zipper data structure, and/or the like).

Although many of the examples discussed herein are provided with use of specific cellular/mobile network terminology, including with the use of 4G/5G 3GPP network components (or expected terahertz-based 6G/6G+technologies), these examples may be applied to many other deployments of wide area and local wireless networks, as well as the integration of wired networks (including optical networks and associated fibers, transceivers, and/or the like). Furthermore, various standards (e.g, 3GPP, ETSI, IEEE, and/or the like) may define various message formats, PDUs, MAC CEs, containers, frames, and/or other data structures, as comprising a sequence of optional or mandatory containers, frames, data elements (DEs), data frames (DFs), information elements (IEs), information object classes (IOCs), managed object classes (MOCs), paramters, attributes, and/or other elements. However, the requirements of any particular standard should not limit the examples discussed herein, and as such, any combination of containers, frames, DFs, DEs, IEs, IOCs, MOCs, parameters, attributes, values, actions, features, and/or other elements are possible in various examples, including any combination of containers, frames, DFs, DEs, IEs, IOCs, MOCs, parameters, attributes, values, actions, features, and/or other elements that are strictly required to be followed in order to conform to such standards or any combination of containers, frames, DFs, DEs, IEs, IOCs, MOCs, parameters, attributes, values, actions, features, and/or other elements strongly recommended and/or used with or in the presence/absence of optional elements.

Moreover, the present disclosure provides various examples of names/labels for various systems, sub-systems, devices, planes, layers, protocols, components, operations, containers, frames, DFs, DEs, IEs, IOCs, MOCs, parameters, attributes, values, actions, features, and other elements/data structures. However, the specific names or labels used regarding the various systems, sub-systems, devices, planes, layers, components, operations, parameters, attributes, IEs, IOCs, MOCs, and other elements/data structures, are provided for the purpose of discussion and illustration, rather than limitation. The various systems, sub-systems, devices, planes, layers, components, operations, parameters, attributes, IEs, IOCs, MOCs, and other elements/data structures can have alternative names or labels to those provided herein. Furthermore, additional or alternative embodiments, implementations, and/or iterations of 3GPP specifications and/or other relevant standards/specifications may name certain elements/entities different to those discussed herein, but still fall within the context of the present disclosure.

Aspects of the inventive subject matter may be referred to herein, individually and/or collectively, merely for convenience and without intending to voluntarily limit the scope of this application to any single aspect or inventive concept. Although specific aspects have been shown and described herein, the present disclosure covers any and all adaptations or variations and any arrangement capable of achieving the same purpose may be substituted for the specific aspects shown and described herein. Combinations of the described aspects and other aspects not specifically described herein will be apparent to those of skill in the art upon reviewing the present disclosure.

1. A method of operating a user plane intelligent controller (UPIC), the method comprising: receiving, from a service consumer, a machine learning (ML) model discovery request, wherein the ML model request includes an ML model filter indicating aspects of a desired ML model; and sending, to the service consumer, an ML model discovery response based on the ML model discovery request.

2. The method of claim 1, wherein the ML model discovery response indicates whether any available candidate ML models that meet the ML model filter have been discovered or found.

3. The method of claim 1, wherein the ML model discovery response includes a set of candidate ML models and corresponding model metadata.

4. The method of claim 1, wherein the ML model discovery response includes: a set of references to storage locations where corresponding ones of a set of candidate ML models can be obtained or accessed; and a set of ML model IDs for the corresponding ones of the set of candidate ML models.

5-25. (canceled)

26. The method of claim 4, wherein the method includes: performing one or more ML model search operations based on the ML model filter.

27. The method of claim 26, wherein the ML model filter includes one or more of: an ML model identifier (ID), version number, developer or vendor ID, system or platform requirements, model parameters, hyperparameter requirements, inference generation speed, and inference accuracy requirements.

28. The method of claim 27, wherein the method includes: receiving, from the service consumer, an ML model training request that includes model parameters, hyperparameters, or training data, or references to where the model parameters, the hyperparameters, or the training data can be obtained; and sending, to the service consumer, an ML model training response indicating whether the training request was accepted or not.

29. The method of claim 28, wherein, when the training is accepted, the method includes: performing an ML model training process based on the ML model training request when the ML training request is accepted; or deploying one or more ML models to a real-time intelligent controller (RTIC) to perform ML model for inference based on the ML model training request.

30. The method of claim 29, wherein the method includes: sending an ML training notification to the service consumer, wherein the ML training notification indicates success or failure of the ML model training process, or the ML training notification includes the trained ML model or a reference to where the trained ML model can be obtained.

31. The method of claim 30, wherein the method includes: receiving a request to retrain the ML model based on an output or event produced by a user plane function (UPF) or the inference output by the RTIC.

32. The method of claim 31, wherein the service consumer is a session management function (SMF), wherein the method includes: receiving an ML model registration request from a model provider; allocating a model ID to an ML model indicated by the ML model registration request; and sending an ML model registration response to the model provider based on the ML model registration request, wherein the ML model registration response includes the allocated model ID,
wherein the model registration request includes model training history, input/output descriptions, software (SW) dependencies, hardware (HW) dependencies, training data set(s),
wherein the method includes: generating one or more tags corresponding to the model ID, wherein the one or more tags include one or more rulesets,
wherein the one or more rulesets include any combination selected from a group comprising: Packet Detection Rule (PDR), Packet Detection Information (PDI), Packet Flow Description (PFD), Forwarding Action Rule (FAR), QoS Enforcement Rule (QER), Usage Reporting Rule (URR), Buffer Action Rule (BAR), Multi-Access Rule (MAR), Session Reporting Rule (SRR), or Policy and Charging Control (PCC) rule,
wherein the one or more tags include one or more of uplink classifier(s), trace requirement(s), port management information container(s), and/or bridge/router information,
wherein the method includes: performing one or more operations for deployment of the ML model to a UPF based on its programmability,
wherein the method includes: receiving, from an RTIC via an Ni4 interface, a request to retrain the deployed ML model using a new or alternative dataset; and providing the deployed ML model to the RTIC over the Ni4 interface based on the request,
wherein the request to retrain the deployed ML model from the RTIC is based on one or more triggers configured at the RTIC, wherein the method includes: sending, to a model training logical function (MTLF), a request to retrain the deployed ML model, wherein the request to retrain the deployed ML model includes the new or alternative dataset or a reference to an analytics logical function (AnLF) where the new or alternative dataset can be obtained; and sending, to the RTIC, a request to deploy the retrained ML model, wherein the request to deploy the retrained ML model is to cause the RTIC to notify the UPF of the deployed ML model,
wherein the RTIC is a function in or part of the UPF, and wherein the model provider is an application function, a Network Exposure Function (NEF), or a network and data analytics function (NWDAF) containing model training logical function (MTLF).

33. One or more computer readable media comprising instructions, wherein execution of the instructions by processor circuitry is to cause the processor circuitry to perform a method of operating a user plane intelligent controller (UPIC), the method comprising: receiving, from a service consumer, a machine learning (ML) model discovery request, wherein the ML model request includes an ML model filter indicating aspects of a desired ML model; and sending, to the service consumer, an ML model discovery response based on the ML model discovery request.

34. The one or more computer readable media of claim 33, wherein the ML model discovery response indicates whether any available candidate ML models that meet the ML model filter have been discovered or found.

35. The one or more computer readable media of claim 33, wherein the ML model discovery response includes a set of candidate ML models and corresponding model metadata.

36. The one or more computer readable media of claim 33, wherein the ML model discovery response includes: a set of references to storage locations where corresponding ones of a set of candidate ML models can be obtained or accessed; and a set of ML model IDs for the corresponding ones of the set of candidate ML models.

37. The one or more computer readable media of claim 36, wherein the method includes: performing one or more ML model search operations based on the ML model filter.

38. The one or more computer readable media of claim 37, wherein the ML model filter includes one or more of: an ML model identifier (ID), version number, developer or vendor ID, system or platform requirements, model parameters, hyperparameter requirements, inference generation speed, and inference accuracy requirements.

39. An integrated circuit comprising one or more of the processor circuitry and the one or more computer readable media, wherein execution of the instructions by the processor circuitry is to cause the processor circuitry to perform a method of operating a user plane intelligent controller (UPIC), the method comprising: receiving, from a service consumer, a machine learning (ML) model discovery request, wherein the ML model request includes an ML model filter indicating aspects of a desired ML model; and sending, to the service consumer, an ML model discovery response based on the ML model discovery request.

40. The integrated circuit of claim 39, wherein the ML model discovery response indicates whether any available candidate ML models that meet the ML model filter have been discovered or found.

41. The integrated circuit of claim 39, wherein the ML model discovery response includes a set of candidate ML models and corresponding model metadata.
